(19) United States
(12) Patent Application Publication
(10) Pub. No.: US 2026/0274729 A1
(43) Pub. Date: Sep. 17, 2026

(54) CLOSED-LOOP WATER SYSTEM WITH INTEGRATED ATMOSPHERIC WATER GENERATION AND GREYWATER RECYCLING

(71) Applicant: Genesis Systems LLC, Tampa, FL (US)

(72) Inventors: Shannon STUCKENBERG, Tampa, FL (US); David STUCKENBERG, Tampa, FL (US); Jonathan MERHEB, Tampa, FL (US); Zach MIXSON, Tampa, FL (US); Owen ERICKSON, Largo, FL (US)

(21) Appl. No.: 19/568,350

(22) Filed: Mar. 16, 2026

Related U.S. Application Data
(60) Provisional application No. 63/773,153, filed on Mar. 17, 2025.

(51) Int. Cl. C02F 9/00; B01D 1/00; B01D 5/00; C02F 1/04; C02F 1/14; C02F 1/16; C02F 1/30; C02F 1/66; C02F 3/12; C02F 3/28; C02F 101/36; C02F 103/00

(52) U.S. Cl. CPC C02F 9/00; B01D 1/0035; B01D 1/0058; B01D 5/006; C02F 1/048; C02F 1/14; C02F 1/16; C02F 1/302; C02F 1/66; C02F 3/1268; C02F 3/2853; C02F 2101/36; C02F 2103/002; C02F 2201/009

(57) ABSTRACT

The present disclosure provides a closed-loop water system. The closed-loop water system may include an atmospheric water generator (AWG) module configured to extract water from ambient air, a greywater recycling module with a membrane bioreactor for treating greywater, water storage units, a humidification module integrated with the AWG and recycling modules, a natural treatment module with a biome for additional natural treatment, and a control and monitoring module with an AI-based controller. The AWG module, greywater recycling module, and humidification module may operate in tandem to form a closed loop, minimizing external water input. The system may extract atmospheric water to compensate for losses and supplement supply, while continuously reusing treated greywater. The AI-based controller may monitor system parameters and automatically adjusts operations based on real-time data and environmental conditions.

### CROSS-REFERENCE TO RELATED APPLICATIONS

This application claims priority to and the benefit of U.S. Provisional Application No. 63/773,153, filed Mar. 17, 2025, and titled “Closed-loop Water System with Integrated Atmospheric Water Generation and Greywater Recycling,” the entire disclosure of which is hereby incorporated by reference herein.

### TECHNICAL FIELD

The present disclosure relates to water management systems, and more particularly to a closed-loop water system integrating atmospheric water generation and greywater recycling.

### BACKGROUND

There is an increasing demand for clean water sources, given the scarcity of water, particularly in arid regions. Thus, there is a substantial benefit to developing new water sources. There are various challenges associated with conventional water supply and management systems. This includes recycling of water and managing contaminants that may be present in recycled water that can pose a safety hazard.

### SUMMARY

In general embodiments of the present disclosure provided herein relate to water management systems, and more particularly to a closed-loop water system integrating atmospheric water generation and greywater recycling to provide a sustainable source of water with minimal external input. Other implementations relating to the closed-loop water system will be, or will become apparent to one with skill in the art upon examination of the following figures and detailed description. It is intended that all such additional implementation be included within this description, be within the scope of the disclosure, and be protected by the claims herein.

In various embodiments, the system is designed to be modular and scalable; suitable for a single residence, a commercial building, an industrial facility, or a municipal installation managing water for a community or city.

According to an aspect of the present disclosure, a closed-loop water system is provided. The closed-loop water system includes an AWG configured to extract water from ambient air via one or more of condensation or sorption to produce purified water. In some embodiments, a system, may include: an atmospheric water generator (AWG) module configured to extract water from ambient air via one or more of condensation or sorption to produce purified water; a greywater recycling module comprising a membrane bioreactor configured to receive greywater from one or more sources, biologically treat the greywater, and filter the treated greywater to produce recycled water; one or more water storage units for storing the purified water and recycled water; a humidification module fluidically coupled with the AWG and the greywater recycling module, the humidification module comprising a humidifier configured to evaporate a portion of at least one of the purified water or the greywater to generate water vapor, the AWG configured to capture the water vapor to produce water; and a control and monitoring module comprising one or more sensors and a controller, the one or more sensors configured to monitor one or more system parameters and communicate a signal indicative of the one or more system parameters to the controller, the controller configured to receive the signal and adjust an operation of at least one of the AWG, the greywater recycling module, or the humidification module based on the received signal.

In some embodiments, a method of providing a sustainable water supply using a closed-loop system includes: generating water from air by operating an AWG to draw in ambient air, extract moisture via cooling or desiccant adsorption, and collect condensed water; distributing the generated water for use within a facility for potable and/or non-potable needs; collecting greywater produced from the facility uses and routing the greywater into a treatment subsystem; biologically and physically treating the greywater in a membrane bioreactor to remove contaminants and produce a purified recycled water stream; reusing the purified greywater by supplying it back to the facility for non-potable uses, thereby reducing the demand for new water; evaporating and re-capturing water within the system by humidifying air with a portion of the water from the greywater or treatment process, and capturing the humid air using an AWG to recover the water, thus recapturing water that would otherwise be lost to evaporation; employing a controller to monitor environmental conditions and system performance, and dynamically adjusting the water generation step and greywater treatment step based on factors including ambient humidity, predicted water usage, and real-time water storage levels; and remotely monitoring the system through IoT connectivity, and sending alerts or taking automated corrective action upon detecting deviations, where the deviations comprise equipment failure or water quality issues); whereby the method yields a continuous loop of water use, treatment, and reuse supplemented by atmospheric extraction.

In some embodiments, a system may include: a humidification module configured to: receive a liquid having a first concentration of a contaminant, and evaporate at least a portion of the liquid to form: a gas having a relative humidity greater than or equal to a predetermined relative humidity threshold, and a liquid concentrate having a second concentration of the contaminant, the second concentration greater than the first concentration; and an atmospheric water generator (AWG) module fluidically couplable to the humidification module, the AWG module configured to receive at least one of the gas or an environmental air and extract moisture from at least a portion of the at least one of the received gas or the received environmental air to produce purified water.

In some embodiments, a method may include causing a portion of a liquid having a first concentration of a contaminant to evaporate to form a gas having a relative humidity greater than or equal to a predetermined relative humidity threshold, a liquid concentrate having a second concentration of the contaminant greater than the first concentration; and causing at least a portion of the gas to condense to produce a purified liquid.

In some embodiments, a method may include: altering a parameter of a liquid containing a contaminant such that at least a portion of the contaminant does not volatilize; evaporating at least a portion of the liquid to form a gas, the gas having a relative humidity equal to or greater than a predetermined relative humidity value; extracting at least a portion of the moisture in the gas via at least one of condensation or sorption to generate a purified liquid.

According to other aspects of the present disclosure, the closed-loop water system may include one or more of the following features. The AWG may include at least one cooling condensation unit with a refrigerated cooling coil configured to cool ambient air below its dew point to condense water vapor into liquid water. The AWG may include a desiccant-based water harvester configured to (i) absorb moisture from air using a hygroscopic material and (ii) release the moisture upon heating for subsequent condensation. The AWG may employ both cooling condensation and desiccant sorption techniques, operating under the control of the AI-based controller to select or switch modes based on ambient humidity and energy efficiency. The membrane bioreactor may use an aeration tank and an integrated ultrafiltration membrane, such that organic pollutants in the greywater are biologically degraded and the resulting water is filtered to remove suspended solids and microorganisms. The membrane bioreactor may be configured to produce high-quality effluent with low turbidity and pathogen content. A UV disinfection unit may be implemented to treat the effluent to ensure it meets safety standards for reuse. The natural treatment module may be a constructed wetland with algae and microbial communities in a series of basins or channels, thereby removing residual nutrients and improving water quality as the recycled water flows through. The natural treatment module may be enclosed in a greenhouse structure and may be fluidly connected to the humidification module so that water evaporated from the biome is captured as water vapor and returned to the system via condensation.

The humidification module may include an evaporation unit that receives water (e.g., from greywater, membrane bioreactor concentrate, wetland or biome), adds it to an air stream as vapor (via heating and/or spraying) to create humidified air, and provide the humidified air to an AWG to produce potable water, such that water from internal sources that would otherwise be lost to evaporation is recovered. Waste heat from the AWG, an HVAC system, industrial waste heat or solar thermal collectors may be utilized to drive the evaporation in the humidification module, and the AWG's cooling mechanism or sorption mechanism may be used to capture the water vapor thereby enhancing overall energy efficiency by heat exchange integration. The AI-based controller may be programmed with a machine learning model that optimizes water production and recycling operations based on real-time sensor inputs and local weather data, including ambient humidity and temperature forecasts, such that the system proactively adjusts to environmental conditions to maintain efficient water output. The controller may adjust the AWG's operation (e.g., fan speed, condenser temperature, desiccant regeneration timing, and/or the like) in anticipation of humidity changes-for example, increasing water harvesting during forecasted high-humidity periods and conserving energy during low-humidity periods-to maximize water yield per energy used. The controller may adjust the greywater recycle rate based on usage patterns, by predicting daily or weekly water demand and ensuring that recycled water and AWG water are produced and stored in advance to meet peak demands, thereby preventing water shortages while minimizing unnecessary operation during low demand. The AI-based controller may implement predictive maintenance algorithms that analyze sensor data trends (pump pressures, membrane flow rates, filter differential pressure, AWG output rates, etc.) to detect anomalies or performance degradation, and in response autonomously initiates maintenance routines (e.g., flushing membranes, defrosting coils, cleaning air filters) and/or generates alerts for human intervention before failures occur.

The closed-loop water system may include IoT-enabled remote monitoring and control functionality, wherein operational data (including water quality, water levels, flow rates, humidity, and system status) is transmitted to a cloud platform, and authorized users can remotely view performance metrics and send control commands to the system via a web or mobile application. The IoT remote monitoring may provide real-time alerts to users or maintenance services upon detection of certain events such as water quality out-of-range, component failure, low water production, or tank overflow risk, enabling prompt response to ensure continuous and safe operation. The remote control capability may allow software updates to the AI controller, remote diagnosis related to system parameters, thereby facilitating system optimizations and troubleshooting without on-site attendance. The system may be built in a modular architecture such that capacity can be scaled by adding or removing modules, including adding multiple AWGs or components in parallel to increase water output, or adding additional membrane bioreactor tanks to handle larger greywater volumes, with the controller automatically recognizing and managing additional modules. For a residential implementation, the modules may be compact and integrated—comprising a household-sized AWG and a greywater treatment unit—while for a municipal or industrial implementation, a plurality of AWGs may be networked together and a plurality of bioreactor units may operate in parallel, all coordinated by a central control and monitoring system to function as a unified water system. The greywater recycling module may be configured to handle variable input and may include an equalization/buffer tank and flow control valves such that intermittent surges of greywater are leveled out, ensuring steady treatment and preventing overload of the bioreactor and membranes. The water storage unit may include a potable water tank holding water from the AWG (and optionally post-processed recycled water) for drinking and cooking use, and a recycled water tank holding treated greywater for non-potable uses (flushing, irrigation, etc.), with backflow prevention and appropriate plumbing to keep the two water grades separate as needed by regulations. The control and monitoring system may be further configured to maintain water quality standards by mixing or purging water as necessary-for example, periodically refreshing the recycled water in storage by using it for irrigation or feeding it to the humidifier for recovery, to prevent stagnation or degradation of water quality over long storage periods.

According to another aspect of the present disclosure, a method of providing a sustainable water supply using a closed-loop system is provided. The method may include generating water from air by operating an AWG to draw in ambient air, extracting moisture via cooling or desiccant sorption (e.g., absorption, adsorption, or the like), and collecting condensed water. The method may include distributing the generated water for use within a facility for potable and/or non-potable needs. The method may include collecting greywater produced from the facility's uses (excluding blackwater sewage) and routing the greywater into a treatment subsystem. The method may include biologically treating the greywater in a membrane bioreactor to remove contaminants and produce a purified recycled water stream. The method may include reusing the purified greywater by supplying it back to the facility for non-potable uses (such as toilet flushing, irrigation, or industrial process water), thereby reducing the demand for new water. The method may include evaporating and re-capturing water within the system by humidifying air with a portion of the water from the greywater or treatment process and then capturing the humid air using an AWG to recover the water, thus recapturing water that would otherwise be lost to evaporation. The method may include employing an AI-based control to monitor environmental conditions and system performance, and dynamically adjusting the water generation stage and greywater treatment stage based on factors including ambient humidity, predicted water usage, and real-time water storage levels. The method may include remotely monitoring the system through IoT connectivity, and transmitting alerts or implementing automated corrective action upon detecting deviations such as equipment failure or water quality issues. The method may yield a continuous loop of water use, treatment, and reuse supplemented by atmospheric extraction, achieving a dramatic reduction in external water input and waste discharge relative to conventional water systems.

According to other aspects of the present disclosure, the method may include one or more of the following features. The step of generating water from air may include operating the AWG preferentially during time periods of higher relative humidity or lower ambient temperature (to improve condensation efficiency), based on weather forecast data input, and idling or reducing operation during less favorable periods, as determined by an AI optimization algorithm. The step of biologically treating the greywater may include maintaining a target biomass concentration and membrane performance in the bioreactor by automatically adjusting aeration rates and performing membrane cleaning when sensor data indicates onset of fouling, under the direction of an AI controller. The step of evaporating and re-capturing water may comprise capturing evaporated water from a humidification module effectively integrating natural water recovery. The AI-based control may use machine learning to learn the usage patterns of the facility such that it can predict daily peaks in water demand and ensure adequate water is produced and stored beforehand, as well as predict periods of low usage to perform maintenance or energy-saving modes. During a detected system anomaly (e.g., water quality falling below a threshold, a pump failure, an AWG under-performance, or membrane clogging beyond a limit), the controller may automatically isolate the affected subsystem/module (e.g., stops supplying substandard water, switches to an alternate water source or mode) and generate an alert via the IoT monitoring system, thereby preventing delivery of improper water and guiding swift maintenance action.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is a block diagram of a water system, according to an embodiment.

FIG. 1B is a schematic block flow diagram a water system, according to an embodiment.

FIG. 1C is a block diagram of a purification module that may be included in the systems of FIGS. 1A and/or 1B, according to an embodiment.

FIG. 2A is a flow diagram of an atmospheric water generator, according to an embodiment.

FIG. 2B is a flow diagram of an alternative atmospheric water generator, according to an embodiment.

FIGS. 2C-2G are example diagrams of a membrane-based water extraction device, according to various embodiments.

FIG. 3 is a block diagram of a membrane bioreactor, according to an embodiment.

FIG. 4 is a block flow diagram of a method of water generation and purification, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Various embodiments of the present disclosure provide a holistic water solution. Example embodiments generate water from the atmosphere, recycle and purify used water, and maintains a balanced closed-loop through intelligent control and natural processes.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “set” and “plurality” can refer to multiple features or a singular feature with multiple parts. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the terms “about” and “approximately” generally mean plus or minus 10% of the stated value. For example, about 0.5 would include 0.45 and 0.55, about 10 would include 9 to 11, about 1,000 would include 900 to 1,100.

As used herein, the terms “substantially” and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “substantially” when used in connection with a numeric parameter is intended to convey that the numeric parameter may vary by about plus or minus about 5%. For example, the term “substantially uniform pressure” implies that the pressure applied may vary ±5% across the entire surface or volume being considered.

The terms “coupled,” and the like as used herein mean the joining of two members directly or indirectly to one another. Such joining may be stationary (e.g., permanent) or moveable (e.g., removable, or releasable). Such joining may be achieved with the two members, or the two members and any additional intermediate members being integrally formed as a single unitary body with one another or with the two members or the two members and any additional intermediate members being attached to one another.

As used herein, the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the term “including,” “comprising,” or “having,” “containing,” “involving” and variations thereof herein, is meant to encompass the items listed thereafter as well as, optionally, additional items. In the description the same numerical references refer to similar elements.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

All definitions, as defined and used herein, should be understood to control over dictionary definitions, definitions in documents incorporated by reference, and/or ordinary meanings of the defined terms.

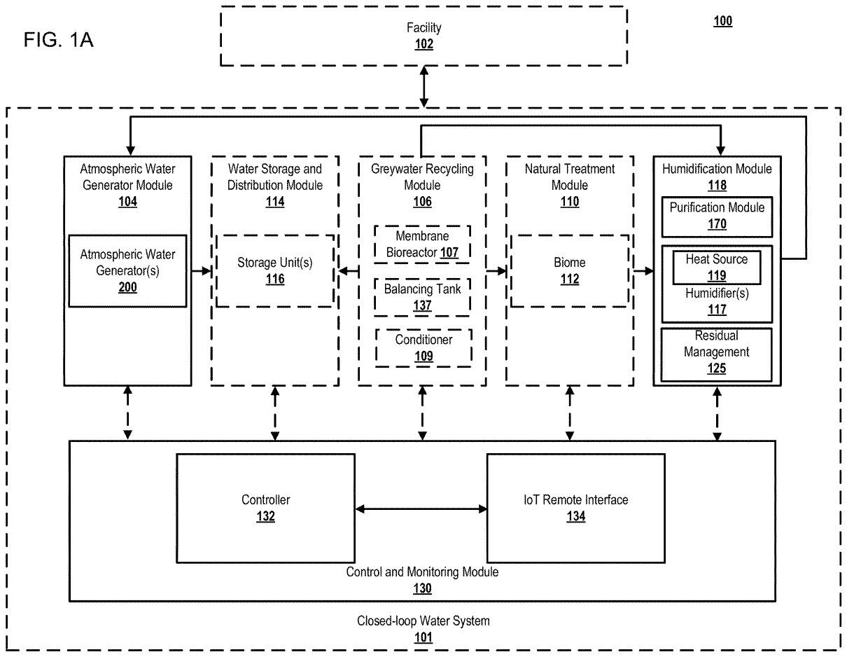

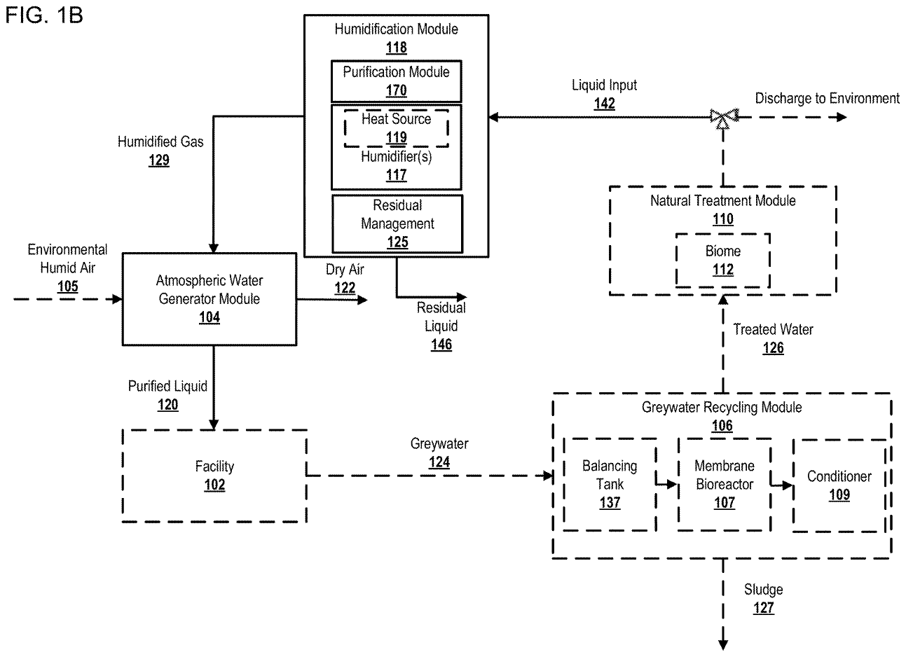

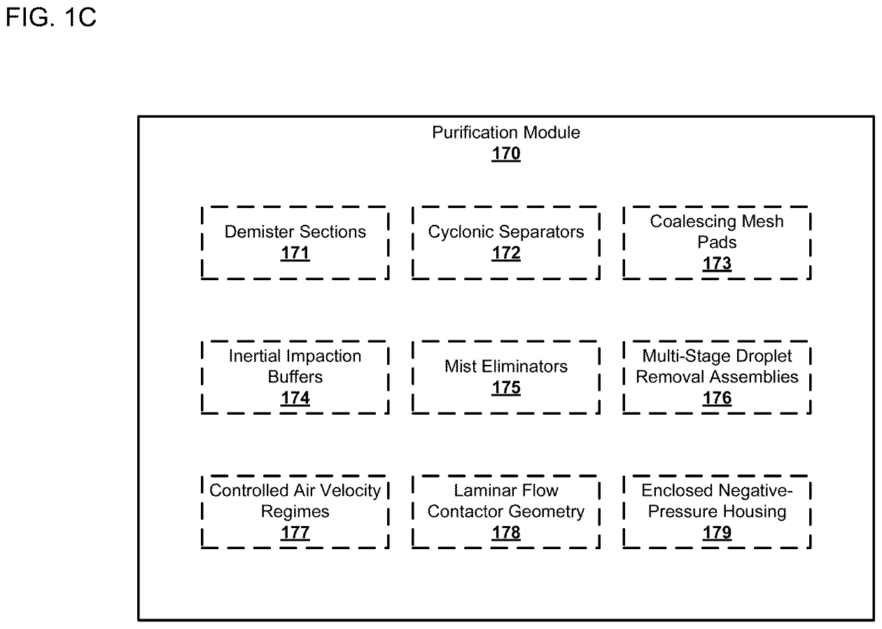

FIG. 1A is a block diagram of a water system 100, according to an embodiment. The depiction of the example water system 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the water system 100 disclosed therein is merely presented to provide an example basis and context for the facilitation of some of the features, aspects, and uses of the methods, apparatuses, and systems disclosed and contemplated herein.

The system 100 includes a closed-loop water system 101 (e.g., closed loop water generation and recycling system 101) configured to generate, treat, and distribute water. The closed-loop water system 101 may be connected to a facility 102, such as a residential, commercial, or industrial building. The closed-loop water system 101 may include an AWG module 104, a greywater recycling module 106, a water storage and distribution module 114, a humidification module 118, and a control and monitoring module 130. In some embodiments, the closed-loop water system 101 may additionally include a natural treatment module 110 (e.g., ecological integration module).

The AWG module 104 may be configured to extract water from ambient air. The AWG module 104 may include one or more AWGs 200 (e.g., one or more AWG systems) for performing and/or facilitating one or more functions of the AWG module 104 including drawing in air and extracting moisture from the air to produce liquid water. As further described herein, the AWG module 104 (e.g., one or more AWGs 200 thereof) may include air intake fans, air filters, a cooling condensation unit (e.g., evaporator coil and compressor system), a desiccant-based sorption unit, and/or a condensation surface or chamber where water vapor is converted to water.

The AWG module 104 may employ one or more operations (e.g., cooling condensation techniques, sorption techniques, and/or other techniques) to capture water vapor and condense it into liquid water (e.g., potable water/purified water). In some embodiments, the AWG module 104 comprises both refrigeration-based condensers (e.g., cooling condensation technique) and desiccant-based harvesters (e.g., sorption techniques) that may be used, individually and/or in parallel, to capture water vapor and condense it into potable water (e.g., purified water). The flexibility to use any of cooling condensation techniques, sorption techniques, or other atmospheric water generation techniques allows the closed-loop water system 101 to operate efficiently under varying/diverse climate conditions. For example, in some example implementation, the AWG module 104 may be configured to utilize cooling condensation to generate potable water from ambient air when the atmospheric conditions are favorable (e.g., above 60° F. and 40% relative humidity (RH)) and utilize sorption/desiccant techniques in dryer cooler conditions.

In some embodiments, the cooling-condensation atmospheric water generation process may work similarly to a dehumidifier or air-conditioner. Ambient air may be drawn in through an air filter (e.g., to remove dust and pollutants). The air may then pass over a refrigerated coil chilled by a vapor-compression refrigeration cycle (e.g., compressor, condenser, expansion valve, evaporator, and/or the like). When the air is cooled below its dew point, the water vapor in the air condenses into liquid water droplets. The droplets may be collected on the coil or in a drip tray and funneled into the system's water storage (e.g., one or more storage units). The refrigeration system may be controlled to produce water during optimal conditions based on humidity and temperature. For example, at night when air is cooler and often more humid, the setpoint may be adjusted for maximal condensation. To ensure water quality, the cooling-condensation atmospheric water generation process may include ultraviolet (UV) sterilization of the collected water and carbon filters to remove volatile organic compounds that may have been present in air and dissolved into the water. In some implementations, the cooling-condensation atmospheric water generation process may be generally most effective in moderate to high humidity conditions and yields high-quality distilled water.

In some embodiments, the desiccant-based atmospheric water generation process may use a hygroscopic material (desiccant) to capture moisture from air. The desiccant may be a solid (e.g., silica gel, zeolite, or metal-organic framework beads, and/or the like) or a liquid brine (e.g., lithium chloride solution, ionic liquids, and/or the like) that has an affinity for water. Air may be blown over or through the desiccant, which absorbs water vapor (or adsorbs water vapor in some embodiments where the desiccant is a solid), to produce dry air exhaust and charge the desiccant with water. The desiccant may then be regenerated by heating it in a closed chamber, causing it to release the absorbed/adsorbed moisture as warm humid air. In some examples, membrane-based techniques such as membrane distillation or osmotically assisted reverse osmosis may be used to achieve separation of the water from the desiccant. In some implementations, the desiccant-based atmospheric water generation process may be advantageous in arid climates, where direct condensation is inefficient. Advanced materials may allow water harvesting at low ambient humidity. In some examples, the heat for desiccant regeneration may be obtained from electrical heating elements, waste heat from industrial processes or generators, or solar thermal collectors, which makes the desiccant-based atmospheric water generation process energy-flexible. In some embodiments the desiccant may be integrated into direct condensation atmospheric water generation process/systems allowing for a desiccant cycle when more energy-efficient such as, for example, when solar heat is available or when humidity is low for direct condensation. The water from the desiccant-based atmospheric water generation process may be collected into storage. In some embodiments, the desiccant-based atmospheric water generation process may include filtering and sterilization.

In some embodiments, the AWG module 104 may comprise one or multiple AWGs 200 of either type (e.g., cooling-condensation atmospheric water generation, desiccant-based AWG), or a combination thereof. For example, in some embodiments, the AWG module 104 may comprise a cooling condensation AWG as the primary AWG and a desiccant-based AWG as a supplemental AWG. In this regard, the closed-loop water system 101 (also referred to herein as “the system 101”) may allow for readily adding atmospheric water generation capacity. For example, in some implementations such as in a municipal-scale deployment, the system 101 (e.g., the AWG module 104 thereof) may employ multiple AWGs working in parallel and coordinated by a central controller (as further described herein) to meet the city's water demand.

In some examples, the collected atmospheric water may be low in mineral content. For example, the collected atmospheric water may be similar to soft, distilled water. In some examples, for human consumption, the collected water may be re-mineralized (e.g., to improve taste and nutritional) by adding trace minerals or by blending with a fraction of water that has minerals. In such examples, the system 101 may include a mineral cartridge or a controlled mixing valve in potable water lines for the re-mineralization.

The AWG module 104 may be configured to provide a continual supply of purified water which can be used directly as drinking water or blended into the system's storage. In some embodiments, the AWG module 104 may output dry air as a byproduct of the water generation process. In some embodiments, the AWG module 104 may output extracted/collected water to a storage facility (e.g., one or more storage tanks) or directly into the usage stream.

In some embodiments, the AWG module 104 may be configured to prevent environmental emissions of per-or polyfluoroalkyl substances (i.e., PFAS) during the operation thereof. For example, in some embodiments, the AWG module 104 may have a closed-loop containment architecture. In some embodiments, the AWG module 104 may include one or more of a contactor or a condensation chamber. In some embodiments, the contactor and condensation chambers of the AWG module 104 may be configured to operate as a sealed system. In some embodiments, at least a portion of the AWG module 104 may be configured to operate under slight negative pressure. In some embodiments, any exhaust air from the AWG module 104 may be purified before being discharged into the ambient environment. For example, in some embodiments, the AWG module 104 may include one or more filters (e.g., HEPA filters and/or carbon polishing filters) through which any exhaust air may be passed before being discharged to the ambient environment.

In some embodiments, the AWG module 104 may include sampling ports configured to enable the sampling of an influent, condensate, and/or effluent of the AWG module 104. In some embodiments, the AWG module 104 may include one or more sensors communicatively connectable to the control and monitoring module 130 and correlated to laboratory PFAS analysis. In some embodiments, the AWG module 104 may be configured to receive a signal from the control and monitoring module 130 to enable an automated sampling of the contents of the AWG module 104 in response to the received signal. In some embodiments, the AWG module 104 may be integrable with analytical frameworks approved by regulatory authorities [e.g., the Environmental Protection Agency (EPA)].

The greywater recycling module 106 may be configured to collect, or otherwise receive, greywater from the facility 102. For example, the system 101 and/or the greywater recycling module 106 thereof may be configured to collect greywater from sinks, showers, washing machines, and/or other sources and treat the collected water for reuse. For example, the output of the greywater recycling module 106 may include treated water (e.g., recycled water) that may be leveraged for non-potable uses (e.g., toilet flushing, irrigation, laundry, etc.) and/or further treated, as described herein. In some embodiments, the greywater recycling module 106 may include a balancing tank 137 for accumulating greywater and equalizing flow, and a membrane bioreactor 107 for biological treatment and filtration of the greywater to output treated water/recycled water. As further described herein, the membrane bioreactor 107 may comprise an aeration tank or bioreactor (e.g., comprising microbes/microorganisms that digest pollutants) and one or more submerged or external filtration membranes (e.g., ultrafiltration membranes or the like) for filtering the water.

For example, when a user in the facility 102 (e.g., building) takes a shower or uses a sink, the greywater flows into the system's collection network instead of being sent down the sewer. A coarse strainer or filter may first be leveraged to remove large particles (e.g., hair, food bits, lint, etc.) to protect downstream equipment. After initial filtering, the greywater may be held in an equalization tank (e.g., balancing tank). The equalization tank may be configured to buffer sudden surges (such as, for example, multiple people showering at once) and provide a steady flow to the membrane bioreactor 107.

The greywater recycling process of the greywater recycling module 106 may correspond to a biological treatment stage of various stages of the water generation and recycling process described herein, wherein the greywater recycling process is configured to treat greywater (e.g., produced by, and collected from, the facility 102) through a combination of biological digestion and membrane filtration. The membrane bioreactor 107 may comprise a bioreactor with microorganisms that break down organic contaminants, and an ultrafiltration membrane (or other type of filtration membrane) that filters out remaining solids and pathogens to produce clean water suitable for non-potable reuse. In various embodiments, the membrane bioreactor 107 is configured to operate efficiently and produce high quality effluent and minimal sludge.

As described above, the output of the greywater recycling module 106 (e.g., the membrane bioreactor 107 thereof) may comprise recycled water (e.g., treated water) for non-potable uses. The recycled water may be routed to storage (e.g., via the water storage and distribution module 114) or routed for further treatment (e.g., via a natural treatment module 110). As described above, in some embodiments, the greywater recycling module 106 may output sludge as a byproduct. Such sludge byproduct may include concentrated bio-solids and may be periodically removed.

As described above, the membrane bioreactor 107 may process greywater to produce recycled water that is clean enough for non-potable uses such as flushing toilets, irrigation, cleaning, cooling tower water, industrial water etc. In some embodiments, the system 101 (or the membrane bioreactor 107 thereof) may include a post-membrane bioreactor treatment stage. In some embodiments, the post-membrane bioreactor treatment stage may include UV disinfection (e.g., to inactivate any remaining microorganisms so as to provide extra safety barrier) and/or chlorination (e.g., to leave a residual that prevents microbial regrowth in storage units). In some embodiments, the system 101 may include UV LEDs or lamps installed, or otherwise disposed, in the effluent tank (e.g., greywater tank) and automatically activating when water flows through.

In some instances, the greywater 124 may include one or more contaminants, for example, a polyfluoroalkyl compound, a fluorinated surfactant, or a related organic compound, which are susceptible to being entrained when the greywater is evaporated or aerosolized, for example, in the AWG module 304. Such contaminants can remain in the evaporated or aerosolized water when it is recondensed to generate the purified liquid 120, which is undesirable. In some embodiments, the greywater recycling module 106 may include a conditioner 109. In some embodiments, the conditioner 109 may be configured to alter a parameter of a greywater 124 which may act as an influent into the greywater recycling module 106. For example, in some embodiments, the conditioner 109 may be configured to reduce at least one of an aerosol formation or a surfactant activity of the influent greywater 124. In some embodiments, the conditioner 109 may be configured to alter a pH of the influent greywater 124 such that per-or polyfluoroalkyl substances (i.e., PFAS) remain in an ionic salt form within the greywater 124 (e.g., by adding an acid or base to the greywater 124). In some embodiments, the conditioner 109 may be configured to maintain the alkalinity of the greywater 124 within a predetermined alkalinity interval. In some embodiments, the conditioner 109 may be configured to alter an ionic strength of the greywater 124. In some embodiments, the conditioner 109 may be configured to introduce an antifoaming agent (e.g., mineral oil, vegetable oil, polydimethylsiloxane, polyethylene glycol, etc.) into the greywater 124 to reduce surfactant activity therein. In some embodiments, the conditioner 109 may be configured to modify a surface tension of the greywater 124. While shown as included in the greywater recycling module 106 in FIG. 1A, in some embodiments, the conditioner 109 may be included in the humidification module 118.

The closed-loop water system 101 may include a water storage and distribution module 114. The water storage and distribution module 114 may include one or more storage units 116 (e.g., comprising one more storage tanks and/or reservoirs) for storing the purified liquid 120 produced by the AWG module 104 and/or the treated water 126 from the greywater recycling module 106.

In some embodiments, the water generation and recycling process may include one or more water storage stages. For example, in some embodiments, the one or more storage units 116 may comprise a potable water tank for storing the purified liquid 120 including a potable water (e.g., purified water) output by the AWG module 104 (e.g., one or more AWGs 200 thereof) and a recycled water tank for storing recycled water (e.g., treated water output by the greywater recycling module 106 (e.g., membrane bioreactor 107 thereof) and/or the natural treatment module (e.g., biome 112 thereof). In some example implementations, the water output may be mixed or used for different purposes. The water storage and distribution module 114 may include one or more sensors and/or other components to facilitate one or more functions of the water storage and distribution module 114 and/or the system 101. For example, in some embodiments, the water storage and distribution module 114 includes level sensors and valves to manage flows between the potable water output from the AWG module 104, the recycled water output from the greywater recycling module 106 and/or the natural treatment module 110, and/or end uses. The water storage and distribution module 114 may be connected to a water distribution network, such as a water distribution network of the facility 102, to supply one or more fixtures (e.g., taps, showers, toilets, irrigation lines, industrial process feeds, etc.). In some embodiments, the water storage and distribution module 114 may include an overflow or a bypass connection to an external drain or backup sewer that serve as a safety mechanism/safety measure in case of system overload or maintenance needs. In this regard, the system 101 may allow for conventional operation where needed.

In some embodiments, a natural treatment module 110 may be incorporated into the closed-loop water system 101. The natural treatment module 110 is designed to naturally polish recycled water (e.g., treated water from the greywater recycling module 106) and provide ecological benefits. In some embodiments, the natural treatment process of the natural treatment module 110 may be an optional treatment stage of the water generation and recycling process described herein. In some embodiments, the natural treatment stage may be subsequent to or parallel to the biological treatment and filtration stage (e.g., greywater recycling module 106). The natural treatment module 110, for example, may be connected to the membrane bioreactor 107.

The natural treatment module 110 may include constructed wetland bed, a vegetated biofilter, and/or or a series of tanks housing aquatic plants and organisms (a “living machine”). For example, the natural treatment module 110 may comprise a biome 112 that includes plants, algae, and/or beneficial microbes/microorganisms. The biome 112 may provide primary, secondary, or tertiary treatment. As water flows through the biome 112, the plant roots and microbes remove residual nutrients and contaminants, thus, improving water quality naturally. Specifically, the microorganisms in the biome 112 may uptake residual nutrients and organic matter to polish, or otherwise cleanse, recycled water (e.g., recycled greywater from the greywater recycling module). In this regard, the biome 112 may serve to provide cleansing function similar to the cleansing function of natural wetlands and an additional layer of water purification with minimal energy input. In some example, the biome 112 may also serve an educational and aesthetic purpose, creating an oasis of greenery.

In some embodiments, the biome 112 is enclosed in a greenhouse or contained environment to allow control of water evaporation. For example, in some implementations, such as large industrial systems, the biome 112 may be realized, or otherwise comprise, constructed wetlands, green walls, or aquaponic systems. In some implementations, such as smaller household systems, the biome 112 may be realized, or otherwise comprise, tanks, containers, and/or the like that house the biome 112. As further described herein, by housing the biome 112 in controlled environments (e.g., a greenhouse or within a facility/building), evaporated water may be harnessed (e.g., captured and utilized to produce additional water) by the humidification module 118. The blending of engineering with ecology, as described herein, facilitates a living water recycling system that is sustainable and resilient.

A humidification module 118 may be integrated with the AWG module 104. The humidification module 118 may be configured to reclaim water through evaporation. For example, the humidification module 118 may create an internal water cycle analogous to rain (e.g., evaporation followed by condensation via the AWG module 104). In some implementations, the humidification module 118 may include one or more evaporative recovery units/evaporative units (e.g., one or more humidifiers 117) connected to the greywater recycling module 106 and/or natural treatment module 110.

The one or more evaporative recovery units may include or more heat sources 119 for evaporating a portion of the treated water (e.g., from the greywater recycling module 106 or natural treatment module 110) or potable water (e.g., produced by the AWG module 104) to generate water vapor. This water vapor may then be captured by the AWG module 104 to produce additional potable water and/or begin another cycle of the closed-loop water system 101 described herein. In this regard, the system 101 may integrate a humidification process within the closed loop configuration of the system 101 to recover water via evaporation to be used as a feed source to the AWG module 104.

In some embodiments, the humidification module 118 may include a purification module 170. In some embodiments, the purification module 170 may be configured to evaporate at least a portion of the water received by the humidification module 118 from the greywater recycling module 106 or the natural treatment module 110. For example, in some embodiments, the purification module 170 may contact at least a portion of an influent liquid into the humidification module 118 with air to cause mass transfer from the influent liquid such that the portion of the influent liquid is evaporated.

In some embodiments, the humidification module 118 may include a residual management 125. In some embodiments, the residual management 125 may be configured to treat a residual liquid containing a high concentration of contaminants, or other undesirable elements within the humidification module 118, for example, concentrated liquid left behind due to evaporation of water thus increasing concentration of contaminant, debris, etc. in the residual liquid.

The humidification module 118 provides for water recovery that complements the membrane-based recycling and atmospheric water generation. This multi-barrier approach ensures the highest water quality and maximizes water recovery in the system 101. For example, where the greywater recycling module 106 (e.g., membrane bioreactor 107 thereof) produces a small stream of concentrate or where there is excess greywater that may not be immediately reused, rather than disposing the concentrate or the excess greywater, the system 101 may funnel the greywater into an evaporative unit (e.g., a humidifier 117).

In some embodiments, the heat source 119 (e.g., a heating mechanism) may include a heat pump, waste heat exchanger, or solar heater that raises the temperature of the water which may be spread onto a surface or through an array of wetted membranes. Air may be blown through the evaporative unit (e.g., humidifier 117) or open to a greenhouse environment, causing the water to evaporate into the air (e.g., producing humidified air). Impurities (e.g., salts, heavy organics, etc.) remain behind, effectively concentrating in a brine or sludge that may be removed periodically. The humidified air (which may be warm and saturated with water vapor) may be directed into the AWG module 104 for water production, as described above.

As described herein, in some embodiments, the system 101 may include a biome 112 which may be implemented as a constructed wetland biome. By way of example, in such some embodiments, on a sunny day, water in the wetland may evaporate as part of the natural process (e.g., transpiration through plants and surface evaporation). According to techniques described herein, instead of losing the evaporated water to the atmosphere, a transparent cover (such as, for example, a greenhouse roof) may be disposed over the wetland to cause the evaporated water to accumulate as humidity (e.g., humid air) inside the covered wetland biome environment. The system 101 may include one or more fans that draw the humid air to the condenser coils of an AWG 200 to reclaim the water, as described above. In this regard, in some embodiments, the wetland may function as a solar-powered humidifier.

In some embodiments, waste heat from other systems may be leveraged to support and/or facilitate the function(s) of the humidification module 118. For example, if the facility 102 includes an HVAC system that rejects heat (such as a condenser unit or industrial process that emits hot air or hot water), the heat may be captured to run the humidifier 117. Warm air may absorb more moisture, thus, preheating the air or water makes the evaporation more effective. The synergy of using waste heat, according to techniques described herein, allows for water recovery with little to no additional energy cost.

In some implementations, the humidification module 118 is especially valuable in scenarios of zero-liquid discharge or when external discharge of water is not desired. The humidification module 118 allows the system 101 to handle the residual brine or sludge water by extracting useful water out of it such that a minimal to no volume of concentrated is produced, which may be disposed occasionally (e.g., solids that can be composted or safely discarded).

As further described herein, in some embodiments, the heat source 119 may include waste heat and/or solar thermal energy. For example, the humidification module 118 may include an evaporation system that uses waste heat or solar thermal energy to evaporate a portion of the greywater and/or concentrate from the greywater recycling module 106 (e.g., membrane bioreactor 107 thereof) into an air stream/recycled humid air, and then routing the moisture-laden air to an AWG (e.g., via an air inlet system thereof). In this regard, the system 101 may create an artificial mini water cycle including evaporating water from the recycling process and then feeding it to the AWG module 104 to obtain purified water. By linking evaporation with atmospheric water generation, the system 101 may recover pure water from impure sources via phase change.

In some embodiments, the humidification module 118 may include one or more spray nozzles or wetting media tower that uses heat to evaporate a portion of wastewater or recycled water to transfer water into the air as vapor. Alternatively, or additionally, the humidification module 118 may also comprise a bed of water in a container where the heat is transferred into the water with an air headspace over the water, allowing for evaporation of water into the headspace. The humidification module 118 may be configured to work synergistically with the AWG module 104 and the natural treatment module 110. For example, air that has passed through the biome 112 (e.g., wetland biome or the like) or a specialized evaporator may be directed into air intake of an AWG, boosting the humidity of intake air and increasing the water yield by the AWG module 104. For example, in embodiments where the system 101 includes an open-air constructed wetland or plant bed (which would normally lose water to evaporation), a transparent enclosure or air-capture hood may collect the humidity and channel it to the AWG module 104 (e.g., to the condenser thereof), to recover the water back into the system. By employing humidification and subsequent dehumidification, the system 101 may reclaim nearly all water content from concentrated waste streams or from the natural evaporation that occurs in open treatment biomes. This evaporative recovery loop significantly reduces water losses and enhances overall efficiency.

The closed-loop water system 101 may also include a control and monitoring module 130. The control and monitoring module 130 may include a controller 132 and sensors for monitoring and adjusting the operations of the various system components. In some embodiments, the controller 132 may be an AI-based controller. Alternatively, or additionally, in some embodiments, the controller 132 may be a centralized controller. The controller 132 may be configured to provide one or more functions including, but not limited to, control, automation, and/or optimization of the system 101. For example, the controller 132 may be configured to run the system's automation. In some embodiments, the controller 132 may comprise a programmable logic controller (PLC) with edge computing or a dedicated computer.

The controller 132 may be configured to interface with sensors distributed throughout the system 101. For example, the AWG module 104, greywater recycling module 106, natural treatment module 110, water storage and distribution module 114, and/or humidification module 118 may each include one or more sensors for measuring and/or monitoring various system/operational parameters. Such sensors may include humidity and temperature sensors (e.g., for measuring and/or monitoring ambient air and one or more parameters of the humidification process, water quality sensors (e.g., for measuring and/or monitoring turbidity, organic content, conductivity, total dissolved solids (TDS), pH, etc. in the recycled water), flow meters, pressure sensors (e.g., on filters), liquid level sensors (e.g., in tanks,), and/or the like. In one example embodiment, one or more temperature sensors and/or humidity sensors may be positioned within a humidifier associated with the humidification module 118.

In some embodiments, the controller 132 may be configured to interface with sensors distributed throughout the system 101 to monitor one or more of the pH, conductivity, oxidation-reduction potential, and/or temperature of the various influents and effluents circulating throughout the system. For example, in some embodiments, the controller 132 may be configured to interface with one or more sensors to monitor the concentration of low-vapor-pressure contaminants in one or more of the liquid input 142, the humidified gas 129 and/or the residual liquid 146. Furthermore, in some embodiments, the controller 132 may be configured to send a signal to one or more of the humidification module 118, the purification module 170, the humidifiers 117 and/or the residual management 125 to alter an operation thereof in response to the monitored low-vapor-pressure contaminant concentration therein.

The controller 132 may be configured to access and/or communicate with external data sources. Such external data sources may include, but not limited to, weather data sources for obtaining weather data (e.g., weather forecasts via internet or other weather data source), energy data sources for obtaining energy data, and/or the like. In some embodiments, the energy data may include energy pricing or availability data (e.g., in embodiments, where the controller 132 is tied/connected to a smart grid or renewable sources on site).

As described above, in some embodiments, the controller 132 may be an AI-based controller that utilizes AI techniques to coordinate the various modules of the system 101 for optimal performance. For example, the controller 132 (e.g., control logic thereof) may employ, or otherwise comprise, one or more AI algorithms designed to optimize performance. In this regard, the controller 132 may employ, or otherwise comprise, an AI component (e.g., one or more AI/ML learning models) trained, configured, and/or the like to perform, facilitate, and/or support various functions of the controller 132 as described herein.

As further described herein, the control and monitoring module 130 (e.g., controller 132 thereof) may be configured to actively manage and optimize the operation of the atmospheric water generation process of the AWG module 104 and the recycling process of the greywater recycling module 106. Alternatively, or additionally, in some embodiments, the control and monitoring module 130 may be configured to actively manage and optimize the operation of the treatment process of the natural treatment module 110, the water storage and distribution process of the water storage and distribution module 114, and/or the humidification and dehumidification process of the humidification module 118. For example, in some embodiments, the control and monitoring module 130 may be configured to manage the humidification process to avoid excessive humidity or condensation in unwanted places. The controller 132 may modulate how much water evaporates based on current humidity. For example, on a humid day, the controller 132 may direct the system 101 (e.g., humidification module 118 thereof) not to evaporate additional water and direct the system 101 (e.g., AWG module 104 thereof) to extract water from ambient air). As another example, on a dry day, and because artificially adding moisture to the air may boost/increase the output of the AWG module 104, the controller 132 may direct the system 101 (e.g., the humidification module 118 thereof) to run during mid-day using solar heat and then condense during cooler nighttime for efficiency. As yet another example, where a condenser of an AWG 200 generates waste heat, the heat may be routed to the humidification module 118, thus creating a closed energy loop.

The controller 132 may receive inputs from one or more data sources (e.g., external sources) and/or one or more sensors (e.g., water quality sensors, water level indicators, flow meters, humidity/temperature sensors, weather forecasts, etc.) as described above. The controller 132 may analyze the received inputs, using one or more AI/ML algorithms, to make real-time decisions.

In some embodiments, the controller 132 may be configured to perform dynamic optimization using weather data. For example, in some embodiments, the inputs received by the controller 132 include, but is not limited to, weather data (e.g., ambient humidity, temperature, upcoming weather forecasts, probability of precipitation, etc.) and usage patterns. The controller 132 may be trained, configured, and/or the like to analyze the weather data and usage patterns to optimize the closed-loop water system 101 including, but not limited to, optimizing when and how to run the atmospheric water generation and greywater recycling processes. For example, the controller 132 may analyze the weather data to make decisions regarding scheduling atmospheric water generation. For example, if an upcoming day is forecast to be hot and dry, the controller 132 may direct the system 101 (e.g., AWG module 104 thereof) to pre-produce extra water during the cooler, more humid night that precedes the hot and dry day and to store the pre-produced extra water for use. Conversely, if a storm is expected (e.g., high humidity or rain), the controller 132 may direct the system (e.g., AWG module 104 thereof) to switch to standby mode to conserve energy or capture rainwater (e.g., rain capture may be an auxiliary input to the system 101). In this regard, the AWG module 104 may operate efficiently by avoiding challenges associated with producing atmospheric water during low humidity hours.

As another example, in some example implementations, if higher humidity is expected at night, the controller 132 may schedule increased atmospheric water generation operation during those hours for improved efficiency. Conversely, during periods of low humidity, the controller 132 may rely on recirculating internal water and trigger the humidification process to increase the efficiency of the atmospheric water generation operation.

The controller 132 (e.g., utilizing AI component thereof) may predict daily water usage patterns in a household and direct the system 101 (e.g., AWG module 104 thereof) to pre-produce water during optimal times (e.g., during high humidity and/or low energy cost periods) to, for example, meet the predicted demand (e.g., forecasted demand). In this regard, the controller 132 may optimize resource generation and storage based on environmental conditions.

Alternatively, or additionally, in some embodiments, the controller 132 may be configured to perform load prediction and management. For example, through learning from historical usage, the controller 132 (e.g., AI component thereof) may predict the demand curve of water usage in the facility. In a home, for example, the controller 132 (using or more AI algorithms) may learn that occupants use X liters in the morning and Y liters in the evening. Based on the learned information, the controller 132 may direct the operation of the various modules of the system 101 in a manner that ensures enough water is produced and treated in advance. In some embodiments, the controller 132 may be configured to balance storage. For example, the controller 132 may be configured to direct the operation of the various modules of the system 101 to ensure that storage water tanks are drawn down to make room for new recycled water, or to ensure that atmospheric water production is monitored and/or timed to mitigate against overflowing the storage water tanks. In some embodiments, such as where the system 101 or controller 132 is connected to multiple houses or a community, the controller 132 may aggregate data to predict community-level demand and manage multiple AWGs 200 and membrane bioreactors 107.

Alternatively, or additionally, in some embodiments, the controller 132 may be configured to perform energy efficiency and source management. For example, where the system 101 is powered by multiple energy sources (e.g., grid and/or solar panels on a house), the controller 132 (e.g., AI component thereof) may direct the system 101 to run energy-heavy tasks (e.g., running the compressor for AWG(s) or pumping water) during times when solar power is available or when electricity tariffs are low. In some embodiments, the controller 132 may be configured to coordinate with any of one or more energy management systems to minimize cost and carbon footprint. In this regard, the AWG(s) may integrate with renewable power, and the controller 132 may facilitate aligning water generation with energy availability. In this regard, in some embodiments, the controller 132 may be configured to reduce energy consumption by intelligent/smart timing of water production by the AWG module 104 during off-peak electricity hours and/or when renewable energy is available.

Alternatively, or additionally, in some embodiments, the controller 132 may be configured to perform and/or facilitate fault detection and maintenance. The controller 132 may be configured to monitor system health and predict maintenance needs. The controller 132 (e.g., AI thereof) may be configured to monitor patterns in sensor data to detect anomalies. By way of non-limiting example, where the output of an AWG (e.g., water output per hour, or the like) drops below a learned baseline (e.g., after accounting for humidity changes), the controller 132 may determine and indicate the filter thereof needs cleaning or the system 101 (e.g., one or more modules thereof) needs maintenance. The controller 132 may cause an alert to be transmitted, where such alerts may indicate the need for maintenance. By way of another non-limiting example, the controller 132 may be configured to detect membrane faults (e.g., membrane fouling) in the membrane bioreactor 107 and/or reduced output of the AWG module 104, and initiate cleaning cycles or alert process (e.g., generate and transmit alerts for display on user devices to alert operators and/or other users of detected faults or reduced performance). For example, the controller 132 may be configured to detect slow increase in membrane pressure differential that indicates fouling. In response to detecting such slow increase in membrane pressure differential, the controller 132 may initiate an automated backwash of the membrane(s) in the membrane bioreactor 107 or schedule a chemical cleaning (e.g., schedule to be completed at nighttime when water demand is low and the membrane bioreactor 107 may be temporarily taken offline). In this regard, the AI-based controller's predictive maintenance capability may reduce downtime by addressing issues before they cause failure. In some example implementations, if the controller 132 (e.g., AI component thereof) detects faults/failures designated as critical (e.g., pump stops, tank overflow risk, water quality out of spec), the controller 132 may direct the system 101 to enter a safe mode (e.g., shutting off the AWG(s) and water supply valves, and alerting the user) to prevent damage or unsafe water delivery.

Alternatively, or additionally, in some embodiments, the controller 132 may allow users to set preferences (for example, how aggressively to conserve energy vs maximizing water production, or setting a priority on water quality levels). In such some embodiments, the controller (e.g., AI component thereof) may operate within the parameters/user preferences. In some embodiments, the controller 132 may communicate with users through a mobile application, web application, or interface, providing insights such as, for example, “your water usage this week was 500 liters, 90% supplied by recycled/atmospheric water, saving X liters of municipal water.” This may educate and encourage sustainable behavior.

Alternatively, or additionally, in some embodiments, the controller 132 may be configured to control and/or cause the AWG module 104 (e.g., one or more AWGs 200 thereof) to adjust to changing humidity and ensure efficient production of potable water (e.g., potable atmospheric water) by the AWG module 104.

Alternatively, or additionally, in some embodiments, the controller 132 may be configured to adjust fan speed, cooling intensity, and/or other operational parameters of an AWG 200. Alternatively, or additionally, in some embodiments, the controller 132 may be configured to direct the AWG module 104 to switch between different modes thereof. For example, the controller 132 may be configured to switch between atmospheric water generation modes (e.g., desiccant mode, cooling mode, and/or other modes) and/or modulate the atmospheric water generation modes. Alternatively, or additionally, in some embodiments, the controller 132 may be configured to regulate the aeration rate and/or membrane flux in the membrane bioreactor 107 to handle variable load. Alternatively, or additionally, in some embodiments, the controller 132 may be configured to control valve(s) that direct water through the biome 112 or the humidification module 118. The controller 132 (e.g., AI component thereof) may continuously learn from past data to improve efficiency and proactively manage maintenance such as, for example, predicting membrane cleaning intervals or refrigerant top-ups.

Furthermore, in some embodiments, the controller 132 may be configured to alter an operation of one or more modules of the closed-loop water system 101. For example, in some embodiments, the controller 132 may be configured to determine a recovery rate of water from one or more modules of the system 101, and the controller 132 may be configured to optimize an energy input into the one or more modules of the system 101 based on the determined recovery rate. In some embodiments, the controller 132 may be configured to send a signal to one or more modules of the system 101 such that the one or more modules of the system 101 alter an airflow therein to reduce the entrainment of contaminant particles based on the received signal. In some embodiments the controller 132 may be configured to determine a temperature differential of a contactor within one or more modules of the system 101 and send a signal to the one or more modules such that the temperature differential of the contactor therein is altered based on the received signal.

The combination of these AI capabilities enables the system 101 to adapt in real-time to both the environment and the users, while seeking optimal balance of water availability, quality, and efficiency.

In some embodiments, the control and monitoring module 130 may include an IoT remote interface 134 for remote monitoring and control of the system 101. The IoT remote interface 134 may be configured to ensure that human operators or service personnel can interface with the system 101 from anywhere. The IoT remove interface may be connected to the controller 132. In some embodiments, the IoT remote interface 134 may be embodied by the controller 132. For example, in such some embodiments, the controller 132 may include the IoT remote interface 134 as a component. The IoT remote interface 134 may be configured to perform and/or facilitate IoT-enabled remote monitoring and management of the system 101. For example, the system 101, via the IoT remote interface, may include network connectivity (e.g., via Wi-Fi, Ethernet, cellular, and/or the like) that allows for remote monitoring and control through, for example, a secure cloud platform.

As described above, various components of the system 101 may be instrumented, comprise, and/or associated with one or more sensors, such that data and/or signals from the one or more sensors is accessible to one or more entities (e.g., authorized users, maintenance providers, etc.) over a network (e.g., internet or other communication network). For example, sensor data and system logs may be transmitted securely to a cloud platform over the network. In one example implementation, at least a subset of the components of the system 101 designated as critical components are instrumented with sensors whose data is accessible over the network to authorized users or maintenance providers. In some embodiments, the IoT remote interface 134 includes a dashboard (e.g., a system status dashboard) accessible remotely to users. For example, the dashboard may be a cloud-connected dashboard that allows for user to access and/or view the dashboard remotely. Authorized users (such as the homeowner, a maintenance service company, or water utility's control center in municipal cases) may log in to view sensor data, system logs, and/or other data transmitted to the cloud platform and accessible via the dashboard. In some examples, the dashboard may display key metrics such as, but not limited to, current water production rate (e.g., AWG L/hour), total water produced today, recycled water flow and quality (e.g., turbidity NTU, or an index of organics), tank levels (in percentage or liters), energy consumption, and status of components (on/off states, any fault codes). In this regard, the dashboard may allow and/or may be leveraged for remote observation of water production rates, water quality (pH, turbidity, etc.), tank levels, and component status.

By allowing for sensor data, system logs, and/or other data to be transmitted securely to a platform for access by user, the IoT remote interface 134 may facilitate accumulation of data that may be analyzed to improve the system 101 and/or various components thereof. For example, data accumulated over months and years and/or data from a single system or multiple systems may be analyzed to find usage trends or to further refine the AI algorithms. This networked approach may lead to continuous improvement and also help verify the system's performance/claims (e.g., water savings achieved).

The IoT remote interface 134 may facilitate and/or enable one or more functions of the control and monitoring module 130. For example, the system 101, via the IoT remote interface 134, may detect if and/or when a monitored parameter goes out of the desired range (e.g., corresponding to a fault or reduced performance such as a pump failure, a drop in produced water volume, or water quality metrics indicating a problem). The system 101 may be configured to generate alert(s) and/or cause implementation of root cause analysis or corrective action(s) in response to detecting a monitored parameter is out of the desired range. By way of non-limiting example, if the water quality sensors indicates that recycled water turbidity or bacterial count (e.g., if a sensor is present or inferred from other readings) is above a safe threshold, the controller 132 may direct the system 101 to automatically halt/stop distribution of the water and notify maintenance or other entities. The system 101 may leverage the IoT remote interface to provide such notification. for example, the IoT interface may be leveraged to send SMS, emails, and/or app notification such as for example: “Warning: Recycled water quality issue detected, system switched to safe mode using stored AWG water only.” Similarly, a component failure (e.g., pump not responding, blower motor tripped, etc.) may trigger an alert so that a technician may be notified and/or dispatched. The IoT remote interface 134 may be leveraged to provide technicians with diagnostic data for troubleshooting. In this regard, the remote monitoring capability ensures that faults/failures (e.g., pump malfunction, filter clog, etc.) within the system 101 can be quickly identified and addressed, thereby reducing downtime and preventing water loss. For example, the IoT remote monitoring may support and/or facilitate rapid diagnosis and response to issues, which minimizes downtime and improves overall efficiency of the system 101.

In some embodiments, the IoT remote interface may enable over-the-air software updates to the algorithms (e.g., control algorithms) leveraged by the controller 132 and/or control and monitoring module 130 to perform various functions thereof. For example, the IoT remote interface 134 may enable updates (e.g., software updates) and optimization (e.g., optimization data) to be pushed to the controller 132. Such updates and optimization may continuously improve the AI/ML algorithms leveraged by the AI controller/AI-based controller 132 and thus improve performance of the system 101 over time.

The remote control capabilities provided and/or facilitated by the IoT remote interface 134 may allow adjustments to be made within the system 101 without being on-site. For example, an operator, via remote commands, may initiate a manual flush of the membranes, update the AI's software, switch the system off in case of an emergency, and/or the like. In some embodiment one or more security mechanisms may be employed to prevent malicious control of the system 101. Such security mechanisms may include, but not limited to, encryption, blockchain implementation, and/or secure tokens for command authenticity.

The AI component may be configured to optimize the control algorithm(s) of the controller 132 and/or the control and monitoring module 130. In some embodiments, the AI component of the controller 132 may comprise a distributed AI model, where the AI model (e.g., AI algorithm(s) thereof) is run at an edge device and only certain output by the AI model is transmitted to the controller 132 as updates and/or optimization data. For example, in some implementations, only data designated as important data is sent back to a main frame to provide updates based on the received data, thus reducing the bandwidth needed for transfer of data relative to conventional systems.

The components of the closed-loop water system 101 may be configured to operate in tandem, facilitating the closed loop configuration of the system 101, where atmospheric water extraction compensates for water losses and supplements water supply, while recycled greywater is continuously reused. The closed-loop configuration, as described herein, may minimize the need for external water input to the system 101.

At least a portion of the system 101 may be modular. For example, various components of the system 101 may be designed and/or are built in a modular fashion. In some implementations, such as for a small residential system, the system 101 may run in a series type flow where the AWG 200 would feed the house water tank, greywater would flow into the membrane bioreactor 107, and then one or more humidifiers 117 where the treated water would be recycled back to the AWG 200. In some implementations, such as for larger installations relative to small residential systems, multiple modules may work in parallel. For example, an array of AWGs may feed a common tank and/or or multiple membrane bioreactor tanks may be leveraged to handle different sections of the facility 102 (e.g., building), and coordinated by a central controller such as controller 132. This modular scalability allows tailoring the capacity of the system to the application's requirements.

FIG. 1B is a schematic block flow diagram of a water system 101, according to an embodiment. The AWG module 104 may receive environmental humid air 105 as input and process the environmental humid air 105 to generate a purified liquid 120 (e.g., purified water). The AWG module 104 may also generate dry air 122. The purified liquid 120 from the AWG module 104 may be distributed to the facility 102 for potable and/or non-potable needs. In some embodiments, the purified liquid 120 may be stored in the water storage and distribution module 114 before distribution to the facility 102.

The facility 102 may produce greywater 124 from various uses, excluding blackwater sewage. The greywater 124 may be collected and routed to the greywater recycling module 106 for treatment. The greywater recycling module 106 may comprise a membrane bioreactor 107 for processing the greywater 124.

The greywater recycling module 106 may output treated water 126 and sludge 127. In some embodiments, the treated water 126 (or portion thereof) may be directed to the humidification module 118 and/or discharged to the environment. In some embodiments, the treated water 126 may be directed to the natural treatment module 110. The natural treatment module 110, containing the biome 112, may provide additional treatment to the water, outputting post-processed treated water 128. The post-processed treated water 128 from the natural treatment module 110 may be reused for non-potable purposes within the facility 102, such as toilet flushing, irrigation, or industrial processes. This reuse may reduce the demand for new water generation.

In some embodiments, a portion of the treated water 126 or post-processed treated water 128 may be directed to the humidification module 118. The humidification module 118 may use the humidifier 117 (e.g., heat source 119 thereof) and/or other components of the humidification module 118 to evaporate water from the post-processed treated water 128 to generate the humidified gas 129.

In some embodiments, the humidification module 118 may include the purification module 170. In some embodiments, the purification module 170 may be configured to contact at least a portion of the liquid input 142 with air to cause mass transfer from the liquid input 142 such that the portion of the liquid input 142 is evaporated. For example, in some embodiments, the liquid input 142 may include low-vapor-pressure contaminants (e.g., per-and polyfluoroalkyl substances (PFAS), fluorinated surfactants, and/or related persistent organic compounds commonly present in groundwater, surface water, industrial wastewater, and AFFF-impacted water). In such embodiments, the purification module 170 may include engineered wetted surfaces along which the liquid input 142 may flow, and may be configured to circulate process air across the engineering wetted surfaces such that water evaporates into the air stream to produce the humidified gas 129. In some embodiments, purification module 170 may be configured to cool the humidified gas 129 to below its dew point.

In some embodiments, the purification module 170 may be configured to alter a parameter of the liquid input 142 such that at least a portion of the low-vapor-pressure contaminants therein do not volatize when contacted with air. For example, in some embodiments, the purification module 170 may be configured to increase a pH of the liquid input 142 such that at least a portion of the low-vapor-pressure contaminants (i.e., PFAS) therein remain in ionic salt form and do not volatize when contacted with air. Additionally, in some embodiments, the purification module 170 may be configured to alter one or more of an alkalinity, an ionic strength, and or a surface tension of the liquid input 142 such that at least a portion of the low-vapor-pressure contaminants therein do not evaporate when the liquid input 142 is contacted by air. In some embodiments, the purification module 170 may be configured to alter the surfactant activity of fluorinated surfactants within the liquid input 142. For example, in some embodiments, the purification module 170 may be configured to use an antifoaming agent to reduce surfactant activity within the liquid input 142.

In some embodiments, the humidification module 118 may include the residual management 125. In some embodiments, the residual management 125 may be configured to prevent environmental emissions of low-vapor-pressure contaminants (e.g., PFAS) during the operation thereof. For example, residual management 125 may be configured to operate under negative pressure to vent exhaust air therefrom and to discharge any exhaust air through one or more of a HEPA filter and/or carbon polishing filters.

In some embodiments, the residual management 125 may be configured to discharge a residual liquid 146. For example, in some embodiments, the residual management 125 may include an automated concentrate bleed and the residual management 125 may be configured to discharge the residual liquid 146 therethrough at predetermined time intervals and/or when the mass of the residual liquid 146 within the humidification module 118 reaches a predetermined threshold value. In some embodiments, the residual management 125 may be configured to operate with a crystallization stage such that the residual liquid 146 is crystallized to significantly decrease the solubility of the residual liquid 146 and prevent the residual liquid 146 from diffusing after being discharged from the humidification module 118. In some embodiments, the residual management 125 may be configured to thermally reduce the volume of the residual liquid 146. In some embodiments, the residual management 125 may be integrated with destructive technologies such that the residual liquid 146 may be safely disposed of.

In some embodiments, the humidification module 118 may include sampling ports enabling the removal of a portion of the liquid input 142, the humidified gas 129, and/or the residual liquid 146 from the humidification module 118 to be used in analytical testing. In some embodiments, the humidification module 118 may be configured to perform one or more operations such as automated sampling and/or data logging to enable accurate measurements of low-vapor-pressure contaminants within the humidification module 118 and ensure compliance with environmental regulations. In some embodiments, the humidification module 118 may include one or more sensors correlated to laboratory PFAS analysis to measure PFAS levels therein. In some embodiments, the humidification module 118 may be configured to be integrable into analytical frameworks which meet environmental requirements as defined by a relevant authoritative source.

In some embodiments, the humidification module 118 may be communicatively coupled to the control and monitoring module 130. In some embodiments, the control and monitoring module 130 may be configured to determine a recovery rate of the humidification module 118 and optimize energy input into the humidification module from the determined recovery rate. In some embodiments, the control and monitoring module 130 may be configured to alter one or more operational conditions of the humidification module 118. For example, in some embodiments, the control and monitoring module 130 may be configured to adjust the flow rate of air contacting the liquid input 142 within the humidification module 118 to minimize entrainment of low-vapor-pressure contaminants therein. Additionally, in some embodiments, the control and monitoring module 130 may be configured to communicate a signal to the humidification module 118 such that the humidification module 118 chemical alters the liquid input 142. In some embodiments, the control and monitoring module 130 may be configured to monitor one or more of the volume or the mass of the residual liquid 146 within the humidification module 118 and to communicate a signal to the humidification module 118 such that it discharges the residual liquid 146 in response to the communicated signal.

The recycled humidified gas 129 may then be fed back to the AWG module 104, completing a cycle of the closed loop configuration of the system 101. The control and monitoring module 130, comprising the AI controller 132, may oversee and adjust the operations of the various system components based on monitored parameters. The IoT remote interface 134 may enable remote monitoring and control of the closed-loop water system 101.

This continuous loop of water use, treatment, and reuse, supplemented by atmospheric extraction, may achieve a reduction in external water input and waste discharge compared to conventional water systems.

In this regard, the combination of AWG and recycling as described herein provides for a system with minimal external water input requirement (e.g., initial startup water and occasional small top-ups), since losses are recaptured as described herein. In this regard, example embodiments described herein may provide near total self-sufficiency in water supply for a household. For larger scales, example embodiments may provide substantial reduction in municipal water draw and wastewater discharge.

FIG. 1C is a block diagram of the purification module 170, according to an embodiment. In some embodiments, the purification module 170 may be configured to modify a parameter of the liquid input 142 such that at least a portion of a contaminant in the liquid input 142 does not evaporate. For example, in some embodiments, the purification module 170 may be configured to increase a pH of the liquid input 142 to at least a predetermined pH threshold such that at least a portion of a contaminant (e.g., PFAS) in the liquid input 142 does not vaporize into the humidified gas 129. In some embodiments, the purification module 170 may be configured to reduce the carryover of droplets entrained with PFAS to the AWG module 104. For example, in some embodiments, the purification module 170 may include one or more sections or segments configured to reduce the carryover of droplets entrained with PFAS to the AWG module 104. These sections or segments may include one or more demister sections 171, one or more cyclonic separators 172, one or more coalescing mesh pads 173, one or more inertial impaction buffers 174, one or more mist eliminators 175, one or more multi-stage droplet removal assemblies 176, a controlled air velocity regime 177, a contactor having a geometry configured to produce a laminar flow 178 (also described herein as the laminar flow contactor 178), and/or an enclosed negative-pressure housing 179.

In some embodiments, the one or more demister sections 171 may be configured to reduce the carryover of entrained liquid droplets (e.g., liquid droplets containing PFAS) from a vapor stream (i.e., the humidified gas 129) into the AWG module 104. For example, in some embodiments, the one or more demister sections 171 may be configured to cause the droplets entrained with PFAS to impact, coalesce, and become large enough such that gravity separates them from the vapor flow (i.e., the humidified gas 129). In some embodiments, the one or more demister sections may include a vane demister and/or a mesh demister. For example, and without wishing to be bound by a particular theory, in some embodiments, the one or more demister sections 171 may be configured to allow gas molecules of the humidified gas 129 to circumvent obstacles in its mesh or vane structure while causing liquid droplets, possessing greater inertia, to collude with the surfaces of the one or more demisters. These collisions may cause the liquid droplets to collect on said surfaces and coalesce into larger droplets and upon reaching a threshold mass, the larger liquid droplets can no longer remain suspended in the humidified gas 129, and are removed from the humidified gas 129 by a gravitational force.

In some embodiments, the one or more cyclonic separators 172 may be configured to reduce the carryover of entrained liquid droplets (e.g., liquid droplets containing PFAS) from the humidified gas 129 into the AWG module 104. In some embodiments, the one or more cyclonic separators 172 may have a substantially cylindrical geometry. In some embodiments, the one or more cyclonic separators 172 may be configured to remove droplets entrained with PFAS from the humidified gas 129 via forming a vortex. As the vortex forms, the particles of the humidified gas 129 collect near the vortex center whereas at least a portion of the droplets entrained with PFAS collect along the inner surface of the one or more cyclonic separators 172 thus separating the liquid droplets from the humidified gas 129.

In some embodiments, the one or more coalescing mesh pads 173 may be configured to reduce the carryover of entrained liquid droplets (e.g., liquid droplets containing PFAS) from the humidified gas 129 into the AWG module 104. For example, in some embodiments, the coalescing mesh pads 173 may include a woven mesh and may be configured to remove droplets entrained with PFAS from the humidified gas 129. In some embodiments, the woven mesh may include a stainless steel, a polymer, or any other suitable material. In some embodiments, the coalescing mesh pads 173 may be configured to reduce carryover of droplets entrained with PFAS into the AWG module 104 of at least about 1 micron, at least about 2 microns, at least about 3 microns, at least about 4 microns, at least about 5 microns, at least about 6 microns, at least about 7 microns, at least about 8 microns, at least about 9 microns, at least about 10 microns, at least about 11 microns, at least about 12 microns, at least about 13 microns, at least about 14 microns, at least about 15 microns, at least about 16 microns, at least about 17 microns, at least about 18 microns, at least 19 microns, or at least about 20 microns. In some embodiments, the coalescing mesh pads 173 may be configured to reduce carryover of droplets entrained with PFAS into the AWG module 104 of no more than 25 microns, no more than 24 microns, no more than 23 microns, no more than 22 microns, no more than 21 microns, no more than 20 microns, no more than 19 microns, no more than 18 microns, no more than 17 microns, no more than 16 microns, no more than 15 microns, no more than 14 microns, no more than 13 microns, no more than 12 microns, no more than 11 microns, no more than 10 microns, no more than 9 microns, no more than 8 microns, no more than 7 microns, no more than 6 microns, no more than more than 5 microns, no more than 4 microns, no more than 3 microns, no more than 2 microns, or no more than 1 micron. Combinations of the above mentioned ranges are also possible (e.g., at least about 5 microns and no more than 22 microns or at least about 10 microns and no more than 15 microns) inclusive of all values and ranges therebetween.

In some embodiments, the one or more inertial impaction buffers 174 may be configured to reduce the carryover of droplets entrained with PFAS into the AWG module 104. For example, in some embodiments, the one or more inertial impaction buffers 174 may include surfaces and/or structures upon which the droplets may collide and coalesce, forming coalesced droplets of sufficiently large mass to be removed spontaneously from the humidified gas 129 by a gravitational force. In some embodiments, the one or more inertial impaction buffers 174 may include planes, vane channels, meshes, baffle plates, cyclonic buffers and/or structural elements of any geometry suitable to enable the droplets to collide and coalesce thereupon.

In some embodiments, the one or more mist eliminators 175 may be configured to reduce the carryover of droplets entrained with PFAS into the AWG module 104. For example, in some embodiments, the one or more mist eliminators 175 may include fiber-bed mist eliminators configured to remove droplets of about 0.1 microns from the humidified gas 129. In some embodiments, the one or more mist eliminators may include surfaces upon which the droplets may collide and coalesce, forming droplets of sufficiently large mass to be removed spontaneously from the humidified gas 129 by a gravitational force. In some embodiments, the one or more multi-stage droplet removal assemblies 176 may include the one or more demister sections 171, the one or more cyclonic separators 172, the one or more coalescing mesh pads 173, the one or more inertial impaction buffers 174, and/or the one or more mist eliminators.

In some embodiments, the controlled air velocity regime 177 may be configured to reduce the carryover of droplets entrained with PFAS and/or other low-vapor-pressure contaminants within the humidified gas 129 into the AWG module 104. For example, in some embodiments, the controlled air velocity regime 177 may be configured such that a drag force from the humidified gas 129 acting upon the droplets is of a smaller magnitude than a gravitational force acting upon the droplets. In some embodiments, the controlled air velocity regime 177 may be configured to work with any one of the one or more demister sections 171, one or more cyclonic separators 172, one or more coalescing mesh pads 173, one or more inertial impaction buffers 174, one or more mist eliminators 175, and/or the one or more multi-stage droplet removal assemblies 176 to further reduce carryover of droplets entrained with PFAS from the humidified gas 129 into the AWG module 104. In some embodiments, the laminar flow contactor 178 may be configured to reduce the carryover of droplets entrained with PFAS and/or other low-vapor-pressure contaminants within the humidified gas 129 into the AWG module 104. For example, in some embodiments, the laminar flow contactor 178 may be configured such that a drag force from the humidified gas 129 acting upon the droplets is of a smaller magnitude than a gravitational force acting upon the droplets.

In some embodiments, the enclosed negative-pressure housing 179 may be configured to reduce the carryover of droplets entrained with PFAS and/or other low-vapor-pressure contaminants within the humidified gas 129 into the AWG module 104. In some embodiments, the enclosed negative-pressure housing 179 may be configured to maintain an internal pressure that is less than the ambient pressure of the surrounding environment. In some embodiments, the internal pressure less than the ambient pressure may cause the humidified gas 129 to spontaneously follow a path of egress from the purification module 170 or a segment thereof that the droplets cannot also traverse.

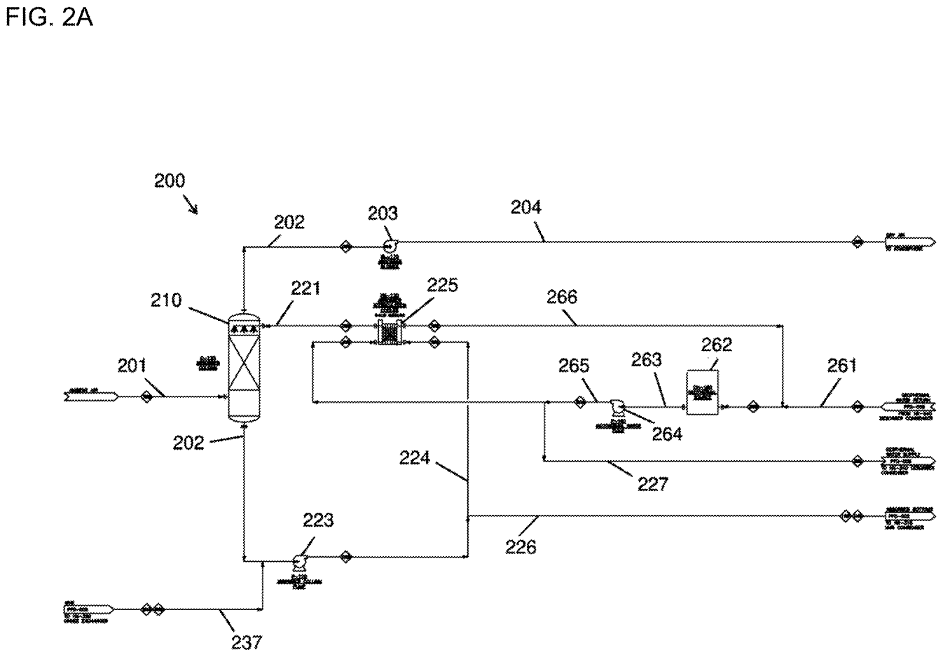

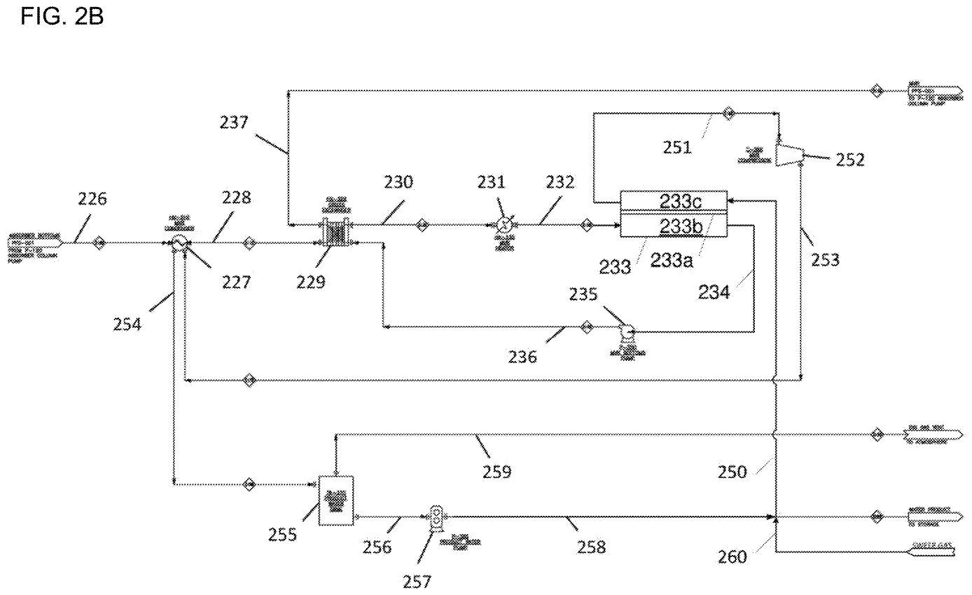

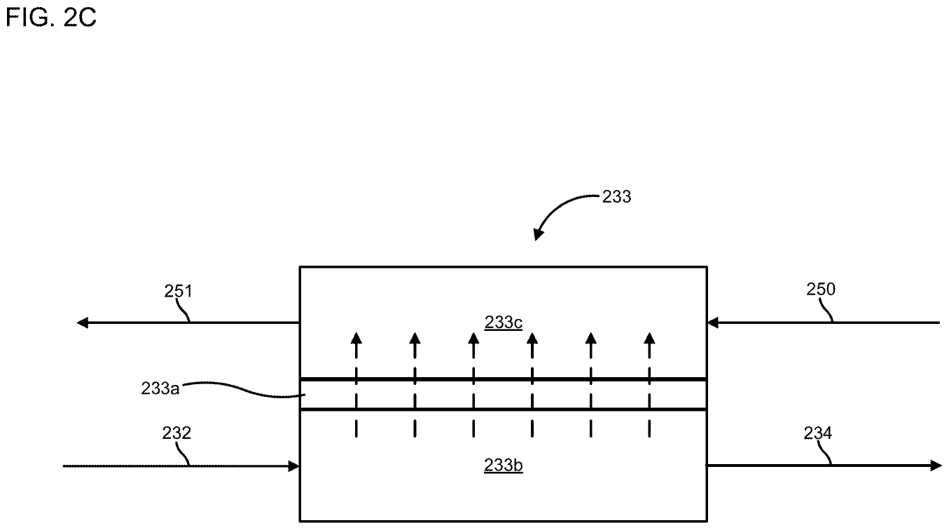

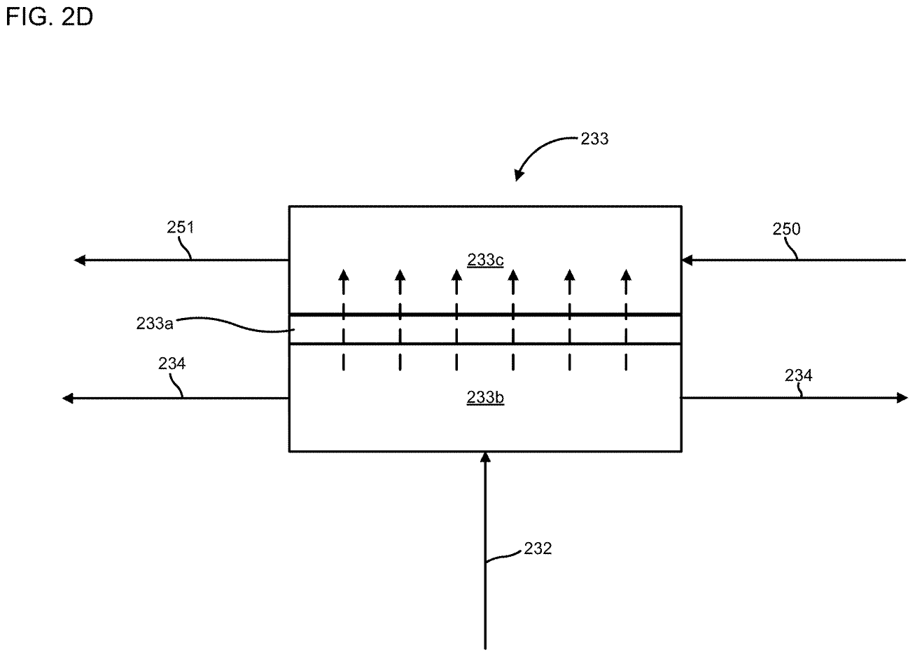

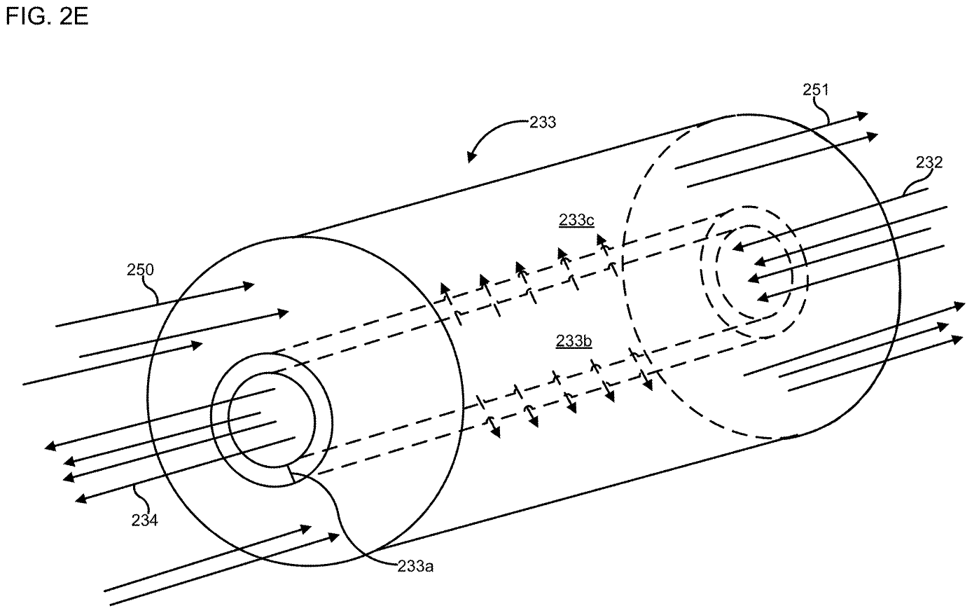

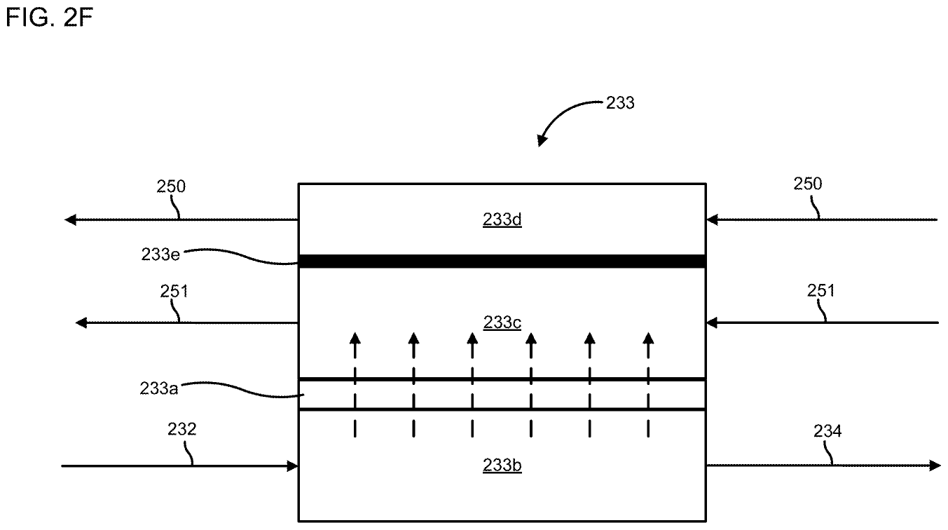

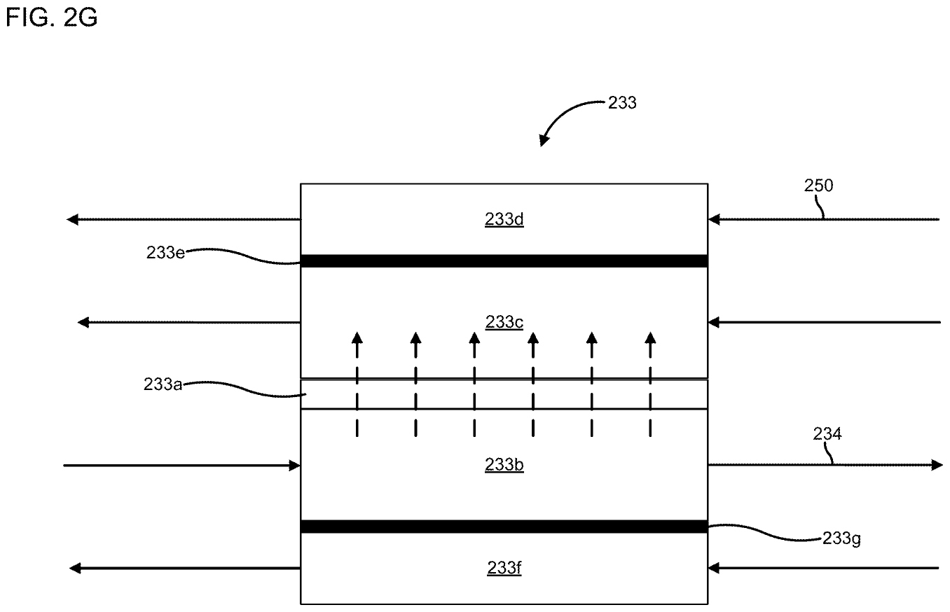

FIGS. 2A-2B illustrate a schematic of an example AWG 200 (e.g., atmospheric water generation system) in accordance with at least some example embodiments of the present disclosure. The depiction of the example AWG 200 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIGS. 2A-2B and the example AWG 200 disclosed therein is merely presented to provide an example basis and context for the facilitation of some of the features, aspects, and uses of the methods, apparatuses, and systems disclosed and contemplated herein.

As described above, the process of atmospheric water generation may include extracting water vapor from atmospheric source air (e.g., ambient air/humid air) at least in part by condensing the water vapor and capturing the condensed, liquid water (e.g., by absorbing the liquid water into a desiccant solution). An AWG 200 may utilize various techniques to extract atmospheric moisture, enabling operation in diverse climates. Such techniques may include cooling-condensation atmospheric water generation and desiccant-based atmospheric water generation techniques.

Certain embodiments comprise steps for preconditioning and/or compressing raw source air (e.g., air at atmospheric conditions) to ease the water extraction process, and/or condensing the water vapor trapped within the raw source air (e.g., by increasing the humidity of at least a portion of the raw source air) to maximize the amount of water vapor that may be extracted from a given unit volume of source air. As discussed herein, processed source air is compressed, consolidated, and/or otherwise manipulated through one or more processes, for example, to ease the water extraction process.

Ultimately, various embodiments of the atmospheric water generation process comprise condensation mechanisms through which source air (e.g., raw source air and/or processed source air, as discussed herein) may be directed over one or more condensation surfaces each having a surface temperature below the dew point of the source air. As the source air flows over and/or around the condensation surfaces, the temperature of the source air adjacent the condensation surfaces drops (e.g., through convective heat transfer), and water vapor within the source air condenses on the condensation surfaces, and the condensed, liquid water flows into a storage vessel (e.g., a capture tank) and/or to one or more related modules (e.g., a greenhouse module) for immediate use.

As noted above, raw source air may be preconditioned to ease the water extraction process utilized to ultimately condense water vapor into usable liquid water. In certain embodiments, the preconditioning process may include steps for compressing the air to increase the vapor pressure of the air (thereby biasing a greater volume of water to the liquid state rather than the vapor state) and/or to decrease the temperature of the source air to a temperature nearer to the dew point. In certain embodiments, an air preconditioning system described herein may be utilized before and/or after a humidity increasing system, such as a desiccant-based humidity increasing system as described herein. Moreover, the air preconditioning system may be utilized before and/or after a carbon dioxide capture system as discussed herein.

As just one example, the air preconditioning process may include a series of compressors/pumps, venturi valves, vortex valves, manifolds, and/or the like collectively configured to decrease the temperature of the source air closer to the air dew point and/or to increase the pressure of the air prior to removing water vapor from the air (e.g., through condensation or absorption by a desiccant). For example, raw source air may be drawn into the air preconditioning system via a vacuum pressure formed at an inlet via a compressor (e.g., a turbine/blower compressor having a plurality of stator or variable pitch turbine blades controllable via servo motors) and/or a centrifugal fan configured to increase the raw air pressure entering the air preconditioning system. In certain embodiments, the compressor and/or centrifugal fan may be rotated via one or more electrical motors (which may receive electrical input power from one or more power systems in communication with the air preconditioning system) mechanically connected with the compressor and/or centrifugal fan via a gear transmission, a belt drive, a chain drive, and/or the like.

In embodiments comprising a centrifugal fan, particulates, dust, and other heavy air contaminants are spun to the outermost edge of the centrifugal fan and are removed from the air stream and ejected from the air preconditioning system. In certain embodiments, the filtered air may be directed into a carbon dioxide capture column, where it is passed over a fixed absorption bed configured to absorb carbon dioxide from the air. For example, air, such as filtered air, may be passed through a carbon dioxide capture system comprising a carbon dioxide capture column having a fixed bed of a carbon dioxide absorbing material (e.g., a sodium hydroxide solution in some embodiments). As air passes over the carbon dioxide absorbing material, the carbon dioxide is absorbed by the material. In certain embodiments, the carbon dioxide capture column may be heated (e.g., with a hot fluid jacket in some embodiments) to facilitate increased carbon dioxide absorption by the absorbing material. In some examples, the carbon dioxide capture material may be configured to reversibly absorb the carbon dioxide, such that the captured carbon dioxide may be compressed and stored as a gas for later use.

In certain embodiments, air, such as filtered air, goes through a sorption process configured to remove water vapor from the air stream before directing the post-sorption air into a carbon dioxide capture column (as described above), where it is passed over a fixed absorption bed configured to absorb carbon dioxide from the air. The carbon dioxide may be separated and directed away from the air stream via a compressor. In certain embodiments, the filtered air (with a reduced carbon dioxide content) may be directed further through the air preconditioning system into a primary manifold, where the air is divided at a selected ratio by a variable plenum/valve. From the primary manifold, a first air stream continues along a bulk air stream, and a second air stream is directed to a vortex tube manifold as discussed herein.

The bulk air stream may proceed through one or more venturi valves each configured to decrease the pressure and temperature of the bulk air stream (the volume and quantity of air remains constant across each venturi valve while the pressure decreases, thereby causing the temperature of the air stream to decrease proportionally to the temperature) and/or through a precooler (e.g., a heat exchanger with a cooling fluid passing therethrough). After proceeding through the one or more venturi valves and/or the precooler, the bulk air stream may proceed to a temperature measurement portion, where the temperatures (e.g., dry bulb and wet bulb temperatures) of the bulk air stream are measured by one or more temperature measurement devices (e.g., thermometers) to determine the dew point of the bulk air stream. Outputs from the temperature measurement devices may be utilized by a controller to mix the bulk air stream with at least a portion of the vortex-chilled air stream to lower the temperature of the bulk air closer to the air dew point. For example, the controller may be in electronic communication with an electromechanical mixing valve that may be selectively opened or closed to vary the amount of vortex-chilled air that is introduced into the bulk air stream. Based on the determined dry-bulb and/or wet-bulb temperatures (as monitored by the controller), the controller may transmit a signal to a motor to move the electromechanical valve to a desired position to obtain a desired mixture of vortex-chilled air with the bulk air stream.

The vortex-chilled air begins as the second stream of air exiting the primary manifold. The second stream of air exits the primary manifold and proceeds to a vortex tube manifold where it is pressurized (e.g., via a compressor) to a sufficient pressure to achieve a drop in temperature of the air travelling through one or more vortex tubes of between approximately 70-150 degrees Fahrenheit. For example, the air may be pressurized to at least approximately 70-120 psi prior to being directed into the one or more vortex tubes. Each vortex tube comprises an entry port directing the stream of air tangentially into an internal spin chamber. As air enters the spin chamber, the air takes on an angular momentum, causing dense, warm air to migrate towards an exterior perimeter of the spin chamber and out of an exhaust valve. In certain embodiments, the warm air may be utilized to heat a carbon dioxide capture column. The remaining, vortex-chilled air migrates toward the center of the spin chamber and out of a vortex outlet. As mentioned above, the vortex-chilled air may be mixed with the bulk air stream to lower the temperature of the bulk air stream closer to the dew point. As yet another alternative, the vortex chilled air may be utilized to chill the precooler through which the bulk air passes.

In certain embodiments, the mixed and chilled bulk air stream is then directed into a condensation chamber, where the water vapor within the air is condensed into liquid water. As just one example, the bulk air stream may be directed over a series of condensation surfaces (e.g., chilled plates, screens, tubes, and/or the like configured to lower the localized temperature of the air at the condensation surfaces below the air dew point, thereby causing the water vapor to condense on the condensation surfaces. The condensed water may then be routed from the condensation surfaces into a retention chamber for collection and later use. However, it should be understood that any of a variety of condensation mechanisms may be used. For example, as discussed herein, one or more desiccant-based condensation mechanisms may be utilized to more effectively remove water vapor from the bulk air stream. Moreover, in certain embodiments the air-preconditioning system may be omitted, and raw air may be filtered and/or directed immediately into a condensation chamber. Such embodiments may have a lower input power requirement, and therefore the amount of power required for water generation may be decreased.

It should also be understood that certain preconditioning system embodiments include one or more filters (e.g., fabric-based air filters, non-woven based air filters, and/or the like), one or more refrigerant systems (e.g., warm air is passed through a heat-exchanger to lower the temperature of the air closer to the dew point), and/or the like in place of or in addition to the vortex and venturi valve mechanisms discussed herein.

As mentioned above, certain embodiments include one or more subsystems configured to increase the humidity of a portion of the source air to increase the amount of water that may be extracted from the source air. Specifically, water vapor may be extracted from a first, large quantity of source air, and may be reintroduced into a second, smaller quantity of source air, thereby consolidating the water vapor of the source air and increasing the humidity of the second quantity of source air before the water vapor in the second quantity of source air is condensed into liquid water.

In some embodiments, the AWG 200 may include at least one air scrubber including a column for contacting atmospheric air (e.g., after increasing the humidity of the air) with a desiccant. In certain embodiments, the desiccant solution may be a fluid, a gel, and/or the like within the typical operating temperature ranges discussed herein. The desiccant may be selected from any of a variety of ionic solutions capable of absorbing water, such as lithium-chloride (LiCl), lithium-bromide (LiBr), Calcium Chloride (CaCl), triethylene glycol, and/or the like. Other, unlisted chemical compounds having hygroscopic characteristics may be provided for use as the desiccant solution in certain embodiments. The hygroscopic fluid may also include surfactants and/or nanofluids. In certain embodiments, the desiccant solution may include a mixture of a plurality of ionic solutions, such as a mixture of LiCl solution and CaCl solution, The desiccant may be dissolved in water to provide a highly concentrated desiccant solution that may be pumped (e.g., via liquid pumps) through the at least one desiccant column. Other materials, including gels, aerogels, desiccant granules flowable subject to granular flow principles, and/or the like may be utilized in place of desiccant solutions in certain embodiments.

Moreover, the amount of water vapor that may be absorbed by the desiccant (and/or released by the desiccant) is dependent on the vapor pressure and temperature of a closed system including the desiccant. Accordingly, various embodiments are configured to absorb water from the air into the desiccant while the vapor pressure in the closed system is high and the temperature is low, and those same embodiments are configured to extract water from the desiccant while the vapor pressure is low, and the temperature is high.

Water may be extracted from air via one or more absorption modules. An AWG (an example of which is shown as system 200 shown in FIGS. 2A-2B) may incorporate a single absorption module or multiple absorption modules. The absorption modules are connected with additional modules within the AWG, including the water extraction module(s) discussed in greater detail below, such that the desiccant can flow between the water absorption module and the additional modules of the AWG. Flow paths to and from the absorption modules within the overall AWG system may be configurable (e.g., configurable via valves between open and closed configurations), such that the absorption modules can operate as closed-modules in a batch-operating mode (with the desiccant flowing only within the absorption module and/or between multiple absorption modules) prior to passing the desiccant to water extraction modules. In other embodiments (e.g., when valves are in an open configuration, or in embodiments without valves), the desiccant flows freely between the absorption module(s) and the water extraction module(s), such as in a continuous flow operating configuration.

Moreover, as mentioned, air entering the absorption module(s) (e.g., via air flow path 201 entering absorber 210 and exiting absorber as dry air via flow path 202-204 shown in FIG. 2A) may flow from a pre-conditioning module configured for increasing the humidity of atmospheric air prior to extracting water from the atmospheric air within the absorber 210. In other embodiments, air may flow directly into the absorption module(s) from the surrounding atmosphere external to the AWG system.

The absorption module according to certain embodiments includes an absorber 210 configured to contact ambient/atmospheric air (e.g., after preconditioning) with a desiccant (flowing through the absorber 210 along flow paths 221-222) so as to absorb water from the atmospheric air into the desiccant. The absorber 210 may be embodied as a vessel in which the desiccant flows between an inlet (via flow path 221) and an outlet (via flow path 222), and the ambient/atmospheric air flows between an air inlet (flow path 201) and an air outlet (flow path 202-204, inclusive of blower 203). Within the vessel, the ambient air contacts the desiccant to enable mass transfer of water vapor from the ambient air into the desiccant. In certain embodiments, one or more baffles, flow interrupters, packings (e.g., structured packing or random packing) may be placed within the absorber so as to increase the surface area of the desiccant and/or to increase the contact time between the ambient air and the desiccant.

In certain embodiments, the absorber 210 is configured in a counter flow configuration where atmospheric air enters the absorber 210 proximate to the bottom of the absorber 210. Dry, atmospheric air then exits the absorber 210 proximate the top of the absorber 210 via a specific flow path (with a pump/blower 203 utilized to move air through the absorber 210). Rich desiccant (e.g., a desiccant fluid) enters proximate the top of the absorber 210 via an inlet flow path 221 and flows down through the interior of the absorber 210 due to gravity. Water is absorbed from the ambient air into the desiccant, such that dilute desiccant exits the absorber proximate to the bottom of the absorber 210 along an outlet flow path 222. In certain embodiments, flow modifiers, such as barriers, mesh, packing components, and/or turns in exit piping from the absorber 210 may be used to reduce carry over of desiccant in the air exit of the absorber 210. In certain embodiments the flow modifiers may be positioned in the interior of the absorber 210 proximate to the top of the absorber 210 (e.g., at a mouth of an exhaust port for dry ambient air to exit the absorber via an exhaust air flow path).

In certain embodiments, the absorber 210 operates in a cross-flow configuration where air enters the absorber from one the side of the absorber 210 and traverses (e.g., at least substantially horizontally) to the other side. Rich desiccant (e.g., desiccant fluid) enters the top of the absorber 210, absorbs water from the ambient air as it flows to a low point in the absorber 210 where dilute desiccant exits proximate the bottom. In this fashion, the air flow is at least substantially perpendicular to the flow of desiccant within the absorber 210. In this configuration, the air inlet and air outlet are approximately at the same height on the absorber 210.

In certain configurations, the absorber 210 is operated in the cross-counter flow configuration where air enters the absorber 210 from one the side of the absorber 210 and traverses to the other side. Rich desiccant (e.g., desiccant fluid) enters proximate the top of the absorber 210 and absorbs water from the ambient air as it flows to a low point in the absorber 210 where dilute desiccant exits proximate the bottom of the absorber 210. In this configuration, the air inlet and air outlet are offset in level from each other. In this configuration, the air inlet can be at the side of the absorber 210 at a location proximate to the top of the absorber 210 and the air outlet is on the side of the absorber 210 proximate to the bottom. In another orientation of this configuration, the air inlet is positioned on the side of the absorber 210 proximate to the bottom of the absorber 210 and the air outlet is positioned on the opposite side of the absorber 210 proximate to the top of the absorber 210. The air travels along a path extending at an angle through the absorber 210 from the top of the absorber 210 to the bottom or the bottom of the absorber 210 to the top.

In certain embodiments, the interior of the absorber 210 includes a plurality of packing components around which the rich desiccant flows as it absorbs water extracted from the humid ambient air. The packing components are provided to increase the surface area of the rich desiccant flowing within the absorber 210 and also to provide a highly tortuous flow path for ambient air flowing through the absorber 210 such that the air has a turbulent flow through the interior of the absorber 210. The absorber 210 may be embodied as a counter flow vessel described above, with the rich desiccant (e.g., desiccant fluid) entering the absorber 210 at a desiccant vessel inlet located at or near the top of the absorber 210, and the ambient air inlet is located at the bottom of the absorber 210. The ambient air flows upwards to a dry air exhaust located at or near the top of the absorber 210, and the desiccant fluid flows downward, across the packing components, to a dilute desiccant outlet of the absorber 210. As examples, the packing components may include individual blocks, balls, trays, baffles and/or any other shape defining a plurality of baffles, slits, holes, meshes, and/or other flow modifying components that may be positioned within the absorber 210 to collectively define a highly tortuous path for the ambient air and the desiccant fluid to pass through the absorber 210. The packing components may include (e.g., be formed of) a material that is not reactive to the desiccant fluid. In certain embodiments, a plurality of packing components (such as an unstructured packing component) may be positioned within the absorber 210 without physically connecting the packing components relative to one another. In other embodiments, a single packing component (such as a structured packing example) sized and shaped specifically for the interior of the absorber 210 may be provided and positioned within the absorber 210.

The packing components of certain embodiments may be placed in a structured configuration to define channels set at different angles to each other with or without holes that collectively define structured flow paths for the ambient air and the desiccant fluid flowing through the absorber 210. To provide a structured packing configuration, the packing components are placed in the absorber 210 in an ordered stacked manner. Packing components can also be positioned randomly in which a plurality of geometrically shaped components are randomly placed in the absorber 210 to increase surface area. Although discussed as a packing-based absorber, it should be understood that the desiccant fluid can be passed through the absorber 210 via other configurations, such as by atomization of a liquid desiccant fluid, by spraying the desiccant fluid within the absorber and/or the like).

In use of an AWG 200, ambient air (at an ambient temperature and an ambient humidity level) is directed into absorber 210 (although not shown, a blower may be implemented at the air intake to the absorber 210 to increase the volumetric flowrate of ambient air entering the absorber 210). In the absorber 210, the ambient air contacts a rich (concentrated) desiccant (e.g., desiccant fluid) provided to the absorber 210 at a low temperature, to increase the vapor pressure within the absorber to encourage water vapor within the humid ambient air to condense and to be absorbed by the desiccant fluid while the humid air contacts the rich desiccant. While the ambient air and the desiccant fluid flow through the absorber 210, humidity within the air condenses and/or is otherwise absorbed into the desiccant fluid to dilute the desiccant fluid and to dry the air. The dry air then exits the absorber back to the atmosphere, as indicated at 202. As shown, a blower 203 may be incorporated at an ambient air exhaust of the absorber 210 to increase the volumetric flowrate of air passing through the absorber 210. The blower 203 may be provided in addition to, or as an alternative to, the above-mentioned blower placed at the ambient air intake of the absorber 210. Moreover, once the desiccant fluid has passed through the absorber 210, a diluted, but still cool, desiccant fluid exits the absorber 210 as indicated at reference 222.

According to certain embodiments, dilute desiccant (e.g., a desiccant fluid) exits the absorber 210 to a pump 223. In certain operation, the absorber module can be operated in a batch configuration where a series of valves may be configured to isolate the absorber module from other portions of the AWG system, and to thereby recirculate the dilute desiccant along a recirculation flow path (while additional rich desiccant fluid is prevented from entering the closed loop via flow path 237 while appropriate valves remain closed) and through a pre-absorber heat exchanger 225 (e.g., a shell-and-tube heat exchanger, a plate heat exchanger, and/or the like) to cool the dilute desiccant (the opposite side of the heat exchanger may be cooled with water that has been collected from the overall system, as discussed in greater detail herein) before it is passed back into the top of the absorber 210 as indicated at 221. In this way, the amount of water absorbed into the desiccant fluid may be increased (thereby increasing the level of dilution of the desiccant) before the desiccant is directed to evaporation portions of the overall system.

In certain embodiments, the absorption module includes a pre-absorber heat exchanger 225 that is cooled through the use of a chiller using a cooling media (e.g., water, glycol, and/or the like) that cools the rich desiccant flowing into the pre-absorber heat exchanger via flow path 224 (e.g., the cooling media is separated from the desiccant, such as on opposite sides of a heat exchanger) before the rich desiccant enters the absorber 210.

In certain operations, the absorber module can be operated in a continuous configuration where valves are configured to recirculate a certain amount of dilute desiccant fluid along the recirculation flow path and a certain amount of dilute desiccant fluid flows toward the water extraction module through a separate flow path (e.g., flow path 226) connecting the absorption module and the water extraction module. In this configuration, a certain amount of dilute desiccant fluid flows along the recirculation flow path through the pre-absorber heat exchanger 225 (e.g., a shell-and-tube heat exchanger, a plate heat exchanger, and/or the like) to cool the dilute desiccant fluid (the opposite side of the heat exchanger 225 is cooled using water that has been collected from the overall system) before it is passed back into the top of the absorber 210 as indicated at 221. Dilute desiccant fluid simultaneously traverses along a separate flow path 226 to the water extraction module. The cooling fluid passes through flow paths 261-267, which encompasses a recirculation loop of fluid, as well as a cooling system 262 and pump 264 that ensures adequate flow of fluid through the pre-absorber heat exchanger 225. Portions of the fluid return to a fluid store via flow path 667.

In certain embodiments, the absorber 210 is configured such that the rich desiccant is not cooled in a heat exchanger. In this embodiment, cooling of the desiccant fluid may be provided via thermal conductive heat exchange with ambient air through the conductive pipes along certain flow paths leading to an intake of the absorber. Fluid cooling may be provided in the absorber 210 as sensible heat is exchanged with the atmospheric air, provided that the air temperature is lower than the entering desiccant fluid temperature.

As just one example, rich desiccant fluid moving toward the absorber 210 may be directed through a series of geothermal tubes having heat transfer properties with surrounding ground beneath the AWG system. The rich desiccant fluid may directly pass through the series of geothermal tubes, or the rich desiccant fluid may pass through a dual-fluid heat exchanger opposite a cooling fluid that is maintained at a desired low temperature via geothermal cooling. As yet another example, the desiccant may pass through a heat exchanger (e.g., a shell-and-tube heat exchanger) to cool the desiccant fluid. The heat exchanger may be cooled via a cooling solution that passes through a refrigeration circuit and/or other fluid chiller to absorb heat from the desiccant fluid before the desiccant fluid enters the absorber 210.

As yet another example, the single-stage water consolidation system may be positioned proximate a high-pressure gas well, such as proximate a natural gas well, an oil well (where natural gas is extracted simultaneously with oil), and/or the like. The high pressure gas may be directed through one or more expansion valves to regulate and/or decrease the pressure of the incoming gas, which, through the Joules-Thompson effect, experiences a rapid temperature decrease (following the gas law formula, the pressure of the gas rapidly decreases across the valve while the volume and amount of gas remains substantially constant, thereby causing a proportional rapid temperature decrease across the expansion valve). The expanded and super-cooled gas may be passed through a heat exchanger opposite the rich desiccant fluid, thereby absorbing heat from the rich desiccant fluid and decreasing the temperature of the desiccant fluid prior to entry into the absorber 210. The expanded gas may then be directed away from the AWG system, where it may be collected for future use, flared off, utilized for power generation (e.g., via a steam turbine), and/or utilized to heat the desiccant fluid entering the water extraction module, as discussed herein.

In certain embodiments the absorber 210 is configured such that the diluted desiccant fluid exits the absorber 210 and is sent to the water extraction module without a recirculation path. Rich desiccant fluid returning from the water extraction module may or may not be cooled with a heat exchanger and/or chiller and/or geothermal cooling prior to entering the absorber 210. For example, dilute desiccant that exits the absorber 210 is pumped along a flow path extending between the absorption module and the water extraction module when appropriate valves are closed to prevent the dilute desiccant from recirculating into the absorber 210 as discussed above.

In certain embodiments, the absorber 210 may be embodied as a membrane-separated absorber, having a desiccant flow path on a first side of a porous membrane, and an air flow path on an opposite, second side of the porous membrane. Separating the air flow path from the desiccant solution flow path may impede undesirable mass flow of the desiccant salt (e.g., aqueous desiccant salt) into the air flow path and ultimately out of the AWG system. Water may be absorbed by the desiccant from the air based on osmotic water flow through the membrane from the air to the desiccant solution. Water vapor may condense on the second side of the membrane, travel through the membrane pores through capillary action, and be absorbed by the high-salt content concentrated desiccant solution. In certain embodiments, the membrane is embodied as a porous membrane, having pores of adequate size (e.g., average pore diameter, maximum pore diameter, and/or the like) to enable water molecules to pass through the membrane while the desiccant salt is prevented from passing through the membrane. As examples, the porous membrane may be a non-woven material, such as polytetrafluorethylene (PTFE), expanded polytetrafluorethylene (ePTFE), polypropylene (PP), polyvinylidene fluoride (PVDF), and/or the like. Other materials, including nylons and/or other synthetic materials may additionally be used in certain embodiments. In various embodiments, synthetic and/or natural materials may be utilized. The porous membrane may be at least partially woven in certain embodiments. In certain embodiments, the membrane may be organic, inorganic, polymeric, mesoporous, ceramic, and/or the like. In certain embodiments, the membrane may include metal organic frameworks, carbon nanotubes and/or a combination thereof. The membrane may be hydrophilic and/or hydrophobic or may be treated (e.g., with a coating) to allow the membrane to be hydrophilic and/or hydrophobic. As example membrane geometries, the membrane may be spiral wound, flat plate and frame style, or tubular. As the desiccant solution and the water flow past opposite sides of the membrane, water molecules migrate from the desiccant solution through the membrane (via capillary action), to the permeate water flow (e.g., water vapor and/or liquid water). In certain embodiments, the membrane may be supported within a frame via spacers, such as a lattice, a grid, and/or the like to provide mechanical support for the membrane to maintain a desired orientation of the membrane within the housing.

Various embodiments of the absorption module comprise a multi-stage absorber configuration, including a plurality of absorbers arranged in series (such that the desiccant flows from a first absorber, through a second absorber, and sequentially through additional absorbers within the multi-stage absorber configuration. Alternatively, the multi-stage absorber configuration encompasses a plurality of absorbers arranged in parallel, such that the desiccant is split to flow through the plurality of absorbers in parallel.

Moreover, the plurality of absorbers may be arranged in series within the air flow path, such that source air may be pulled from the environment and passed through the plurality of absorbers in series prior to being exhausted back to the environment as dry air. For example, the source air may be first passed through the low concentration absorber to absorb a first quantity of water from the air, then may be passed through the high concentration absorber to absorb a second quantity of water from the air. Because the initial absorption uses less energy (and does not use a low vapor pressure between the air and the liquid desiccant), the initial absorption using the lower concentration desiccant fluid may enable absorption of a first quantity of water from the air. After the initial, low energy requirement absorption process is completed, the air (which still contains water vapor) is passed through the second absorber having a higher concentration desiccant fluid, such that a second quantity of water is absorbed from the air. The now dry (e.g., low humidity) air may then be exhausted from the system to the environment.

On the desiccant side, once the dilute desiccant exits the low concentration absorber, the desiccant fluid passes to a water extraction module as discussed herein to extract water therefrom (and to consequently reconcentrate the desiccant). In certain embodiments, each absorber may be in fluid communication with a corresponding water extraction module, such that each absorber is associated with a separate and independent desiccant flow path loop. For example, a first quantity of desiccant fluid may flow between a first absorber and a first water extraction module, and a second desiccant fluid may flow between a second absorber and a second water extraction module, and the first quantity of desiccant fluid does not mix with the second quantity of desiccant fluid. In certain embodiments, the first quantity of desiccant fluid may comprise a first desiccant (e.g., LiCl) and the second quantity of desiccant fluid may comprise a second desiccant (e.g., CaCl).

Moreover, in embodiments comprising a plurality of independent desiccant flows, each desiccant flow may have a different concentration range. For example, a first desiccant flow (e.g., corresponding to a first absorber passed through by source air) may have a first concentration range measured between a high concentration value at an exit of the water extraction module and a low concentration value at an exit of the absorber; and a second desiccant flow may have a second concentration range. As the source air is directed through the absorption columns in series, the air may be directed through a low concentration range absorption column first and may be directed through a high concentration range absorption column second.

The water extraction module is provided to remove water from a diluted desiccant (e.g., from a diluted desiccant fluid) for storage and use as potable water or for other clean liquid water uses. The water extraction module includes one or more membrane-based water extraction devices (e.g., connected in series or in parallel) and is connected to the absorption module via various flow paths to enable desiccant (e.g., diluted desiccant and rich desiccant) to flow between the absorption module and the water extraction module. The membrane-based water extraction device (also referred to as a fluid separation device) also acts to concentrate the desiccant solution into a concentrated desiccant retentate solution which may be reprocessed through the atmospheric water generation system.

The water extraction module includes at least one membrane-based water extraction device 233 defining two flow paths separated by a permeable membrane 233a. On a first side of the permeable membrane 233a, the desiccant flows along a desiccant flow path (between flow path 232 and flow path 234) and on the opposite, second side of the permeable membrane, permeated fluid (e.g., water vapor) is captured then transferred (within portion 233c, located within the water extraction device between flow path 250 and flow path 251). Both the desiccant (on the first side 233b of the permeable membrane 233a) and the captured permeate fluid (on the second side 233c of the permeable membrane 233a) are in contact with opposite sides of the permeable membrane 233a while flowing past the permeable membrane 233a. The membrane 233a may thereby separate the desiccant flow path from the captured permeate (water vapor) flow path, which includes water vapor collected during the water collection/fluid separation process (e.g., water vapor that migrates through the porous membrane 233a) and condenses into a liquid permeate water flow (e.g., downstream of the membrane-based water extraction device). In certain embodiments, mass transfer of water vapor across the membrane 233a may be driven by raising the vapor pressure of the desiccant. This may be accomplished by heating of the desiccant prior to contact with the membrane 233a (on the desiccant side 233b of the membrane). Lowering the pressure (e.g., by using a vacuum mechanism) to reduce the pressure on the permeate side 233c of the membrane 233a, also causes mass transfer of water vapor across the membrane. As the desiccant flows past the porous membrane 233a (on the first, desiccant side 233b of the membrane), the water in the desiccant begins permeation across the membrane 233a in the vapor state and exits the membrane 233a (on the second side) in the vapor state. The water vapor then condenses as it cools and flows along the water flow path (e.g., at least partially by utilizing a heat exchanger (e.g., condenser 227) and/or contacting it with a colder fluid (e.g., condensed water)).

In certain embodiments, the desiccant side 233b may be heated by a heating fluid (e.g., heating oil, steam, glycol, and/or the like) that is separated from the desiccant flow path within the membrane-based water extraction device via a heat-conductive layer (e.g., a heat-conductive, non-porous film, a metal sheet, and/or the like. In certain embodiments, the desiccant side 233b may be embodied as a shell-and-tube heat exchanger, with the heating fluid flowing through tubes and the desiccant flowing through the shell, with certain wall(s) of the shell being embodied as the porous membrane 233a. In certain embodiments, the heating fluid may be a product of the AWG system, thereby utilizing sensible heat transfer to heat the desiccant fluid to encourage water vapor migration across the membrane. In other embodiments, the heating fluid may be a product (e.g., a final product, a waste product, or an intermediate product) of a spatially proximate process, such as mining, gas extraction, power production, and/or the like.

As discussed in greater detail herein, the permeate side 233c may similarly include a heat-exchanger configuration to lower the temperature of the permeate fluid to encourage condensation thereof. For example, a cooling fluid (e.g., liquid water extracted from a liquid water storage tank 255, a refrigerant (e.g., glycol), and/or the like) may be separated from the permeate flow path by a heat-conductive layer (e.g., a heat-conductive, non-porous film, a metal sheet, and/or the like). The cooling fluid cools the heat-conductive layer, thereby providing a surface within the permeate fluid flow on which water vapor can condense. In certain embodiments, the permeate side 233c may be embodied as a shell-and-tube heat exchanger, with the cooling fluid flowing through tubes and the permeate fluid flowing through the shell, with certain wall(s) of the shell being embodied as the porous membrane 233a. In such embodiments, the outer surfaces of the tubes are provided as condensation surfaces for the water vapor. In certain embodiments, the cooling fluid may be a product of the AWG system (e.g., liquid water), thereby utilizing sensible heat transfer to cool the permeate to encourage water vapor migration across the membrane and to encourage condensation of the water vapor.

The membrane 233a may include a hydrophobic porous membrane, such as non-woven membrane having a small pore size. As just one example, the membrane may comprise PTFE, ePTFE, PP, PVDF, and/or the like, that is hydrophobic by design. In certain embodiments, the membrane may be organic, inorganic, polymeric, mesoporous, ceramic, and/or the like. In certain embodiments, the membrane may include metal organic frameworks, carbon nanotubes and/or a combination thereof, such as by stacking layers of material. The membrane may be hydrophilic or hydrophobic or may be treated (e.g., with a coating) to allow the membrane to be hydrophilic and/or hydrophobic. The use of a hydrophobic material (or a material having a hydrophobic coating) encourages water vapor to selectively pass through the membrane to be retained on the permeate water side 233c of the membrane. Adhering a layer of hydrophobic material to the membrane on the desiccant side 233b causes only volatile vapors to pass through and fluids in the liquid state are retained on the desiccant side 233b of the membrane. As examples of membrane geometries, the membrane may be spiral wound, flat plate and frame style, or a hollow tube. As the desiccant solution flows across the desiccant side 233b of the membrane, water molecules migrate from the desiccant solution through the membrane (via capillary action) in the form of vapor, to the permeated water side 233c, leaving a highly concentrated desiccant solution on the desiccant side 233b of the membrane 233a.

The membrane-based water extraction device 233 is embodied as a housing having a desiccant inlet and a desiccant outlet on the desiccant side 233b of the membrane 233a, and a permeate inlet and a permeate outlet on the permeate side 233c of the membrane 233a. In other example embodiments, the membrane-based water extraction device 233 may utilize gravity to remove permeate fluid from the membrane-based water extraction device 233, and in such embodiments, the permeate flow path may not include an inlet (such that gravity alone is sufficient to move the permeate fluid through an outlet of the device). For example, as the desiccant fluid flows from an inlet to an outlet of the membrane-based water extraction device, water vapor migrates through the membrane into vapor form on a permeate side of the membrane. The permeate side of the membrane may be cooled (e.g., using a cooling fluid separated from the permeate side of the membrane by a heat-conductive film), and water may condense within the permeate side of the membrane-based water extraction device and may fall (under the force of gravity) through an outlet port located on a bottom end of the permeate-side of the membrane.

The desiccant flow path extends between the desiccant inlet and the desiccant outlet. The permeate (water) flow path extends between the permeate inlet and the permeate outlet. In certain embodiments, the permeate outlet may be located below (and on an opposite end of the membrane-based water extraction device) the permeate inlet so as to utilize the force of gravity to encourage flow of permeate out of the membrane-based water extraction device. As mentioned above, each of the desiccant flow path and the permeate flow path interface the porous membrane 233a on opposite sides thereof. By separating the desiccant fluid from the permeate flow, the membrane 233a impedes mass transfer of dissolved solids from the desiccant into the resulting permeate flow, thereby preserving the desiccant for continuous usage and preserving the purity of the captured water. Similarly, the membrane impedes migration of a gas (e.g., a sweep gas) on the permeate side of the membrane 233a from permeating into the desiccant flow.

In certain embodiments, the housing defines two parallel flow paths that contact opposite sides of the porous membrane 233a in a counter-cross flow manner as illustrated in FIG. 2C, with the first flow path being the desiccant flow path 233b and the second flow path being the permeate flow path 233c, and the porous membrane 233a is embodied as a planar membrane (e.g., defined within a frame) that separates the desiccant flow path 233b from the permeate flow path 233c. In certain embodiments, the housing is configured to grant access to the porous membrane for maintenance purposes, such as to replace the membrane as needed. In other embodiments, a first flow (e.g., the desiccant flow) may flow in a horizontal direction across the surface of the membrane 233a) and a second flow (e.g., the permeate flow) may flow in a vertical direction across the opposite surface of the membrane, such as with the outlet of the permeate flow being below the inlet of the permeate flow.

In other embodiments, the desiccant flow path may be defined by a desiccant inlet that directs the desiccant toward the membrane (e.g., at a perpendicular angle or an at least substantially perpendicular angle relative to a first side of the membrane), and the desiccant is directed toward an outlet after the desiccant contacts the membrane. This embodiment is a dead end-style flow, where inlet desiccant interfaces the porous membrane in an at least substantially normal (perpendicular) direction of the permeate flow path on the opposite side of the membrane. In this embodiment, the permeate flow path flows parallel to the porous membrane. An example of this configuration is illustrated in FIG. 2D.

In yet other embodiments as illustrated in FIG. 2E, the housing may define a lumen-style flow path, with a first flow path being at least substantially concentric to a second flow path. Walls of the first flow path (separating the first and second flow path) may be at least partially defined by the porous membrane. In certain embodiments, the porous membrane may extend partially around the first flow path. In other embodiments, the porous membrane may extend around an entirety of the first flow path. As just one example, the first, interior flow path may be the desiccant flow path, and the second, outer flow path may be the permeate flow path, such that permeate water migrates through the porous membrane from the interior flow path to the exterior flow path. As another example, the first, interior flow path may be the permeate water flow path and the second, outer flow path may be the desiccant flow path, such that permeate water migrates through the porous membrane from the exterior flow path to the interior flow path.

In the lumen-style flow of the membrane-based water separation device, the permeate flow path and the desiccant flow paths may extend in the same co-current direction or in counter-current (opposite flow) directions. In certain embodiments, the flows may be horizontal, or vertical. In a vertical orientation, the permeate side may flow downward, thereby utilizing gravity to facilitate flow of the water (after condensation) out of the membrane-based water separation device.

To achieve separation of water from the desiccant solution, a difference in chemical potential is introduced. This may be realized in a temperature gradient across the membrane, a pressure gradient across the membrane, and/or a concentration gradient across the membrane between the desiccant flow path 233b, the membrane 233a, and the permeate flow path 233c. A temperature gradient across the membrane may be achieved by heating the desiccant fluid path 233b and/or cooling the permeate liquid water path 233c. The temperature of the desiccant fluid and/or the liquid water may be manipulated through the use of any heating/cooling source to include but is not limited to, heat exchangers, heating elements, waste heat, geothermal heat, solar heating, geothermal cooling, chilling, cooling pond, cooling stream, sweep gas, and/or the like. For example, the membrane-based water extraction device may incorporate a heat-exchanging configuration, such as across a non-porous film on a desiccant side of the membrane (e.g., a heating fluid may heat the desiccant fluid as it flows across a surface of the membrane) and/or a cooling configuration may be incorporated on the permeate side of the membrane (e.g., a cooling fluid separated from the permeate fluid across a non-porous film may cool the permeate fluid). A pressure gradient across the membrane may be achieved by high pressure on the desiccant side of the membrane and/or low pressure on the liquid water side of the membrane. The difference in pressure between the desiccant side of the membrane and permeate side of the membrane may be introduced by mechanisms including but not limited to, high pressure pumps, pumps, blowers, compressors, vacuum pumps, venturi vacuum induction mechanisms, and/or the like. Moreover, one or more pumps and/or agitators may be utilized on the desiccant side or the permeate water side to ensure homogeneity of properties of the desiccant and/or liquid water. Ultimately, the difference in pressure and/or temperature may provide a difference in vapor pressure on the two sides of the membrane to encourage water vapor to migrate through the membrane from the desiccant side of the membrane to the permeate/water-vapor side of the membrane. Specifically, the vapor pressure on the permeate side of the membrane may be lower than the vapor pressure on the desiccant-side of the membrane (e.g., to utilize an induced vacuum to drive permeation of the water through the membrane).

In certain embodiments, the membrane-based water extraction device is configured to utilize the mechanisms mentioned above to drive chemical potential. In one example incorporating vacuum membrane distillation (VMD), the permeate outlet path 251 is pressurized to a vacuum pressure (e.g., utilizing one or more vacuum pumps located downstream of the membrane-based water extraction device 233 along the permeate flow path, such as at compressor 252) to induce a pressure gradient across the membrane. As just one example, a vacuum pump may be located in the permeate water storage tank 255 and/or along flow path 259 of a gas vent from the water storage tank 255. In this embodiment, the absolute pressure on the desiccant side 233b is greater than the absolute pressure on the permeate side 233c. The interior of the membrane-based water extraction device may be analogous to that shown in FIGS. 2C-2E. In certain embodiments, additional components, such as a heating fluid flow and/or a cooling fluid flow (as discussed below) may additionally be incorporated into the VMD configuration of the membrane-based water extraction device to further enhance the efficiency of the water extraction process.

Another example embodiment utilizes air gap membrane distillation (AGMD) processes to drive permeation of water vapor across the membrane 233a to the permeate side 233c of the membrane 233a. Example AGMD configurations are shown in FIGS. 2F-2G, each of which provides for the permeate side of the membrane 233c to carry a cooling fluid along a cooling fluid flow path that is separated from the permeate flow path 233c by a heat-conductive, non-porous film (e.g., cooling water directed from storage tank 255, along flow path 258 to flow path 250 and into the membrane-based water extraction device 233 on the permeate side 233c of the membrane 233a). The cooling fluid flowing along flow path 233d sandwiches an air gap between a non-porous membrane 233e (separating the cooling fluid flow path 233d from the permeate side 233c of the membrane) and porous membrane 233a. The created air gap is formed with non-porous membranes 233e that promote condensing via heat transfer. The air gap serves as a path for condensates once they have separated from the desiccant via porous membrane. The cooling fluid is at a temperature below the heated desiccant fluid, thereby creating a temperature gradient starting from the heated desiccant side of the module 233b and finishing at the cool non-porous membrane holding the cooling fluid. The cool side also causes the transferred vapors to condense into a liquid state. A higher temperature gradient (a greater difference between the heated desiccant fluid and the cooling fluid) creates a greater driving force to separate water molecules within the concentrated desiccant across the porous membrane, thus achieving greater separation performance for the membrane-based water extraction device. As discussed above, the water vapor within the air gap may be directed out of the housing of the membrane-based water extraction device based on a vacuum created within the air gap, based on a sweep gas flowing through the air gap, and/or based on gravity that forces condensed water to flow downward and out through an outlet located at a bottom end of the air gap. In certain embodiments, the housing defines three outlets: a desiccant outlet (to flow path 234), a permeate outlet (to flow path 251), and a cooling fluid outlet (to recirculate cooling fluid along a cooling fluid flow path). In certain embodiments, the housing defines at least two inlets (when an inlet is not required for the permeate fluid, such as when gravity is utilized to direct the permeate fluid to exit the air gap) comprising a desiccant inlet (from flow path 232) and a cooling fluid inlet (e.g., from flow path 250). In other embodiments, the housing defines at least 3 inlets (when a permeate flow inlet is required, such as when utilizing a vacuum pressure or a sweep gas to direct the permeate out of the housing), comprising a desiccant fluid inlet (from flow path 232), a permeate fluid inlet (e.g., to enable a gas flow through the permeate side 233c of the membrane), and a cooling fluid inlet (e.g., from flow path 250).

Although illustrated as a flat-plane non-porous membrane 233d, it should be understood that the permeate side of the membrane 233a may be embodied as a shell-and-tube heat exchanger configuration (with the walls of the tubes embodying the non-porous film 233e and the cooling fluid flowing within the interior of the tubes).

Moreover, certain embodiments may provide an analogous configuration on the desiccant side of the membrane by utilizing a heating fluid separated from the desiccant by a non-porous, heat-conductive film, as shown in FIG. 2G. In such an embodiment, the heating fluid (e.g., a heating oil, steam, a heated refrigerant, and/or the like) passes along a flow path through heating fluid flow 233f, on an opposite side of the non-porous film 233g from the desiccant fluid 233b. The heating fluid transfers heat to the desiccant flowing through desiccant flow 233b, which encourages water vapor transmission across the porous membrane 233a. Particularly when the heating fluid flow 233f configuration is incorporated together with the cooling fluid flow 233d configuration, a large difference in chemical potential is introduced between the desiccant flow 233b and the permeate flow 233c to encourage migration of water across the membrane 233a. As discussed above, the water vapor within the air gap may be directed out of the housing of the membrane-based water extraction device based on a vacuum created within the air gap, based on a sweep gas flowing through the air gap, and/or based on gravity that forces condensed water to flow downward and out through an outlet located at a bottom end of the air gap. In certain embodiments, the housing defines three outlets: a desiccant outlet (to flow path 234), a permeate outlet (to flow path 251), a heating fluid outlet (e.g., to recirculate the heating fluid along a heating fluid flow path) and a cooling fluid outlet (to recirculate cooling fluid along a cooling fluid flow path). In certain embodiments, the housing defines at least three inlets (when an inlet is not required for the permeate fluid, such as when gravity is utilized to direct the permeate fluid to exit the air gap) comprising a desiccant inlet (from flow path 232), a heating fluid inlet, and a cooling fluid inlet (e.g., from flow path 250). In other embodiments, the housing defines at least four inlets (when a permeate flow inlet is required, such as when utilizing a vacuum pressure or a sweep gas to direct the permeate out of the housing), comprising a desiccant fluid inlet (from flow path 232), a permeate fluid inlet (e.g., to enable a gas flow through the permeate side 233c of the membrane), a heating fluid inlet, and a cooling fluid inlet (e.g., from flow path 250).

By separating the permeate flow 233c from the cooling fluid 233d as illustrated in either of FIGS. 2F-2G, the efficiency of permeation of water through the membrane may be increased due to a low vapor-pressure on the permeate side 233c of the membrane. A vacuum pressure, a sweep gas, and/or other flow-encouraging mechanisms may be implemented within the permeate flow 233c to encourage the water vapor on the permeate side 233c of the membrane to exit through the permeate outlet of the membrane-based water extraction device 233 and to be guided to one or more compressors (to incorporate beneficial features of mechanical vapor compression. The water vapor exiting the permeate outlet of the membrane-based water extraction device may flow to one or more heat exchangers and/or one or more condensers 227 to condense the water vapor into liquid water before storing the same within storage tank 255.

Other embodiments implement direct contact membrane distillation (DCMD) processes to drive chemical potential across the membrane 233a. In a DCMD configuration, the permeate water side 233c of the membrane 233a carries a cooling fluid (e.g., cooling water) that directly contacts the porous membrane 233a. In such a configuration, water is directed from the storage tank 255 directly to the permeate flow 233c to maintain a low temperature on the permeate side 233c of the membrane 233a. Because the cooling fluid is at a lower temperature than the desiccant fluid, the cooling fluid creates a temperature gradient across the membrane 233a, starting from the heated desiccant side 233b and finishing at the direct contacting cooling fluid on the permeate side 233c of the membrane 233a. The cooling fluid may be retrieved from the storage tank 255 and directed into the membrane-based water extraction device 233 along flow paths 258 to 250 to 233c (and out of the membrane-based water extraction device at flow path 251). In certain embodiments, a portion of the water exiting the storage tank 255 along flow path 258 may be directed to external systems for use as liquid water. The permeate side 233c of the membrane 233a is fed by cooling fluid (e.g., liquid water from storage tank 255), which causes water vapors that have permeated through the membrane 233a to condense and transfer the water vapors separated from the concentrated desiccant. A higher temperature gradient (a greater difference between the heated desiccant fluid and the cooling fluid) creates a greater driving force to separate water molecules within the concentrated desiccant across the porous membrane, thus achieving greater separation performance for the membrane-based water extraction device.

As yet another example, a sweep gas membrane distillation (SGMD) process may be utilized to create a chemical across the membrane 233a. SGMD configurations may be combined with AGMD and/or DCMD to drive further efficiency of such configurations. According to an SGMD configuration, the permeate water side 233c of the membrane 233a carries a sweep gas (e.g., nitrogen gas, high-humidity air, inert gas, and/or the like) that transports permeated fluid (e.g., water vapor) away from the porous membrane 233a after it has permeated through the porous membrane. In certain embodiments, the sweep gas may carry the permeated water vapor to a compressor 252 and/or a condenser 227, where the water vapor condenses into liquid water. The sweep gas may be separated from the permeated water vapors by bringing the mixture to the water dew point and ultimately the sweep gas may be directed away from the liquid water along flow path 259, leading out of the storage tank 255. The sweep gas may be directed back to a storage tank, and it may be recycled into the system along flow path 260 as discussed above. Condensing the permeated water vapor into liquid enables the water to be stored in the product water tank 255. In certain embodiments, the SGMD configuration utilizes an inert gaseous state fluid as a sweep gas that does not contaminate the product water. In certain embodiments of SGMD, the flow of gas into the permeate flow path 233c is heated to retain the physical state of the permeated water (vapor state). To aid in maintaining the vapor state, heat tracing elements can be utilized to prevent the fluid pipe walls from cooling the fluid to liquid state. The water vapor may then be transported to a condenser 227 downstream from the membrane-based water extraction device 233 to condense the water, which is then stored within the water storage tank 255. Moreover, in the SGMD embodiments, the sweep gas may be introduced along flow path 260 and 250 into the membrane-based water extraction device. The sweep gas may be directed away from the liquid water after condensation by directing the sweep gas out of the water storage tank, such as along flow path 259 as shown in FIG. 2B.

In certain embodiments, the water extraction module comprises one or more heating mechanisms along a flow path leading the desiccant fluid into the intake of the membrane-based water extraction device (on the desiccant side 233b of the membrane 233a). In one example embodiment, the desiccant fluid is heated to a temperature between about 40° C.-80° C. The process may result in adequate separation even at low temperatures (approximately 40° C.). In certain embodiments, the efficiency of separation may be increased at higher temperatures (e.g., between about 60° C.-80° C.).

For example, diluted desiccant leaving the absorber module passes through one or more heating subsystems between the absorber module and the membrane-based water extraction device. These heating subsystems are provided as a part of the water extraction module. The one or more heating subsystems may include one or more of: a condenser 227, a pre-extraction heat exchanger 229, and/or a heater 231. It should be understood that the one or more heating subsystems may be provided in any order relative to the flow of desiccant. In one example, the diluted desiccant, which remains cool after passing through the absorber 210, passes through a condenser 227 which utilizes the generally cool temperature of the dilute desiccant to encourage condensation of water vapor from water vapor flowing along the permeate water flow path 251-254 (e.g., the water flow path encompassing the water flow path on the second side of the porous membrane). In certain embodiments, the condenser 227 is a shell-and-tube heat exchanger, with the dilute desiccant (upstream of the membrane-based water extraction device 233) passing through the tubes, and the water vapor condensing on the exterior of the tubes within the shell of the heat exchanger. In another embodiment, the condenser 227 is a plate-and-frame heat exchanger, with the dilute desiccant fluid passing through one set of plates and the water vapor passing through the other set of plates, and the water vapor condenses in the heat exchanger as it traverses through the heat exchanger as it warms the dilute desiccant. In another embodiment, the condenser 227 is a double-pipe heat exchanger where the dilute desiccant passes through the inner pipe and the water vapor passes through the outer pipe such that it can condense on the exterior surface of the inner pipe. In certain embodiments the condenser 227 may have a counter-flow configuration (the dilute desiccant flowing in an opposite direction than the water vapor). In other embodiments, the condenser 227 may have a parallel, co-current flow configuration in which the dilute desiccant and the water vapor flow in the same direction through the condenser 227.

The dilute desiccant exiting the condenser 227 via the flow path represented at 228 has an increased temperature due to a certain amount of heat transfer that is transferred from the water vapor to the dilute desiccant within the condenser 227. The dilute desiccant then passes through a pre-evaporator heat exchanger 229 (e.g., a shell-and-tube heat exchanger, a plate-and-frame heat exchanger, a dual-tube heat exchanger (with concentric tubes), and/or the like) and/or heater 231 (e.g., an externally powered heater, such as an electric heater, a natural gas heater, a solar heater and/or the like) to increase the temperature of the dilute desiccant to or near the evaporation temperature. In certain embodiments, the heater may be an inline electric heater with heating element bundles for heating the dilute desiccant fluid. The heater may have an orientation to reduce the likelihood of fluid flashing on the elements. The heater 231 may be positioned within the housing of the membrane-based water extraction device. In certain embodiments, the heater is a heat exchanger (e.g., a shell-and-tube heat exchanger, a plate-and-frame heat exchanger, and/or the like). In certain embodiments, the heater 231 is a solar heater utilizing photovoltaic panels to generate electrical energy to drive electrical heater elements (e.g., resistive heater elements). In certain embodiments, the heater 231 is a frenal lens heater utilizing solar energy to generate thermal energy in the form of heat. In certain embodiments, the heater 231 includes a geothermal heater mechanism including a series of pipes extending into the ground to utilize geothermal energy to heat the dilute desiccant fluid. In other embodiments, the heater 231 is a fired heater utilizing a hydrocarbon fuel source (e.g., natural gas, oil, wood, biomass, and/or the like) combined with oxygen (supplied from ambient air) to create heat from combustion.

In embodiments comprising both a pre-extraction heat exchanger 229 and heater 231, the dilute desiccant fluid first exits the pre-extraction heat exchanger 229 via flow path represented at 230 before entering the heater 231. Moreover, as discussed in greater detail herein, the opposite side of the pre-extraction heat exchanger 229 is provided with heated rich desiccant fluid exiting the membrane-based water extraction device.

As the desiccant flows out of the heater 231 (if used), it flows along a flow path 232 into the housing, specifically into the desiccant inlet of the membrane-based water extraction device. In the membrane-based water extraction device, the desiccant solution is brought into direct contact with the membrane. Utilizing the difference in temperature, pressure, and/or concentration, the water migrates though the membrane and is collected on the second side. The water may migrate through the membrane as a liquid and/or as a vapor. The water may then be distributed for use and/or collected in a storage tank 255. In certain embodiments, the vapor on the liquid water side of the membrane may be collected in cool liquid water or another cool fluid to condense the vapor. The vapor on the liquid water side of the membrane may be swept away from the membrane using a sweep gas that flows through the membrane-based water extraction device on the liquid water side of the membrane. The vapor may then be condensed in a further process using a heat transfer process such as a heat exchanger or other embodiment of heat transfer process to condense the water vapor into liquid water (the opposite side of the heater exchanger and/or condenser may define a portion of a flow path of a chilled fluid, such as the dilute desiccant prior to entry into the desiccant side of the membrane-based water extraction device). In certain embodiments the vapor directly enters a heat transfer process on the permeate side of the membrane after exiting the membrane-based water extraction device 233. The heat transfer process may be a heat exchanger 229 or other embodiment of heat transfer process to condense the water vapor into liquid water. In other embodiments, a vacuum may be induced on the permeate side of the membrane to achieve a difference in pressure between the desiccant side and permeate side of the membrane. The water enters the membrane as a liquid and/or vapor and exits the membrane on the permeate side as a vapor. The water flow path leads the water into a storage tank 255 (via flow paths 251-254, inclusive of pump(s), heat exchanger(s), compressor(s), and/or other flow-assisting devices. The water flow path also circulates from the storage tank via flow path 250 (inclusive of one or more pumps in certain embodiments, not shown) to the membrane-based water extraction device 233. In certain embodiments, a sweep gas (e.g., humid air) is blown through the water flow path (e.g., via a blower in-line with the water flow path) to push water vapor out of the membrane-based water extraction device 233 into the compressor 252 and ultimately into the condenser 227.

In certain embodiments, the vapor on the permeate side is compressed through mechanical and/or thermal means to a higher pressure (e.g., via compressor 252). The vapor is then passed through a heat exchanger 227 to allow the latent heat to be used to heat the desiccant solution. Through this heat exchanger the vapor is also condensed as a liquid.

The membrane-based water extraction device 233 may be configured for batch operation, wherein the desiccant circulates within a closed loop to repeatedly contact the desiccant fluid with the membrane (without directing the desiccant to the absorption module) until a desired quantity of water has been separated. Valves within the water extraction module may be configured to provide the closed-loop flow of the desiccant solution. After the concentration of the desiccant solution reaches a desired level, the desiccant solution is then sent back to the absorption module by reconfiguring the valves to enable flow of desiccant from the water extraction module to the absorption module. The membrane-based water extraction device 233 may encompass a system of parallel subunits where multiple membranes are held in a single apparatus and/or multiple membrane-based water extraction devices are operated in parallel (with each device operating to separate water from a portion of the desiccant solution). In certain embodiments the membrane separation subunits may also be configured in a series configuration. In this configuration the desiccant solution is contacted with the first membrane and a certain amount of water migrates through the first membrane. The retentate desiccant solution from the first membrane is fed to a second membrane as the desiccant solution where an additional quantity of water is separated from the desiccant solution. The process is repeated for the number of membrane separation subunits in the series setup. In certain embodiments a combination of the parallel and series units may be utilized.

In certain embodiments the membrane-based water extraction device 233 is configured for continuous operation where a stream of desiccant is flowed in direct contact (e.g., perpendicular, parallel or tangential to the membrane face) with the membrane, and water is continuously separated from the desiccant solution via the membrane. The continuous mode operation may utilize series and/or parallel subunits as described in the section above. During continuous operation, the desiccant flows in a continuous loop from the absorption module to the water extraction module and back to the absorption module.

In certain embodiments, the membrane-based water extraction device may be provided in combination with an evaporation-based water extraction device (e.g., an evaporation vessel for evaporating water from the desiccant, and a condenser for condensing the evaporated water into potable liquid water). For example, the membrane-based water extraction device may be provided upstream (along the desiccant flow path) from an evaporation vessel. The membrane-based water extraction device may alternatively (or additionally) be positioned downstream (along the desiccant flow path) of an evaporation vessel as discussed above.

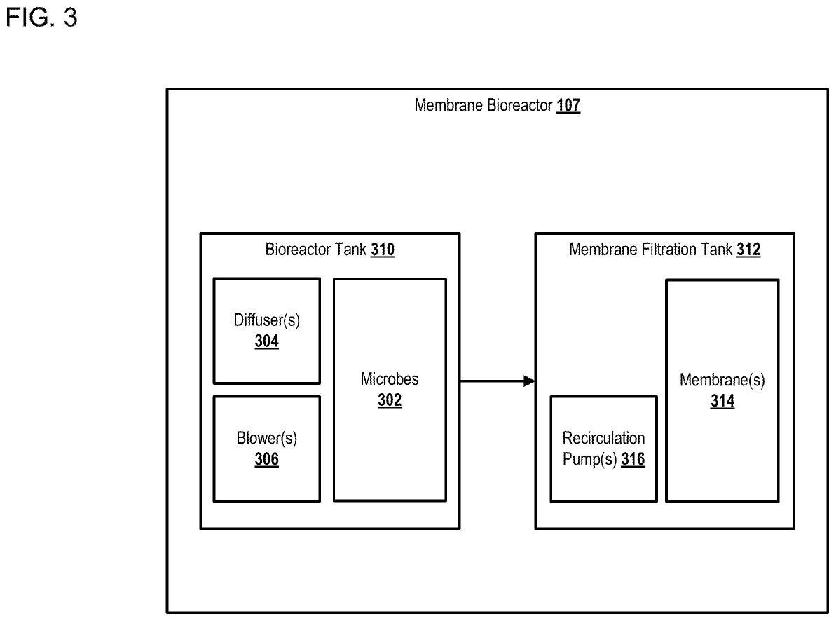

FIG. 3 is a block diagram of a membrane bioreactor 107, according to an embodiment. The depiction of the example membrane bioreactor 107 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 3 and the example membrane bioreactor 107 disclosed therein is merely presented to provide an example basis and context for the facilitation of some of the features, aspects, and uses of the methods, apparatuses, and systems disclosed and contemplated herein.

The membrane bioreactor 107 may include a bioreactor tank 310 and a membrane filtration tank 312. In some embodiments, the greywater may undergo two simultaneous treatments in the membrane bioreactor 107. For example, the greywater may undergo biological degradation in the bioreactor tank 310 and undergo membrane filtration in the membrane filtration tank 312.

The bioreactor tank 310 may contain several components for processing greywater. In some embodiments, one or more diffusers 304 may be positioned within the bioreactor tank 310 for supplying air (e.g., oxygen). For example, the bioreactor tank 310 may be aerated with one or more diffusers 304 that supply air (oxygen) to support aerobic microbes in the bioreactor tank that digest organic pollutants in the greywater and break down the organic matter into simpler compounds. These microbes (e.g., naturally occurring or inoculated bacteria) may digest organic pollutants (e.g., soap residues, skin cells, and oils from showers, or food particles from kitchen sinks) in the water. Over time, the microbes break down this organic matter (e.g., organic pollutants) into simpler compounds (e.g., CO₂, water, biomass, and/or the like). Nutrients like nitrogen and phosphorus may also be taken up or converted by the microbial community.

In some embodiments, the bioreactor tank 310 may include one or more blowers 306. The one or more blowers 306 may be configured to support and/or facilitate aeration within the bioreactor tank 310. In some embodiments, the one or more blowers 306 may be communicatively connected to the controller 132 such that the controller 132 (e.g., AI component thereof) may throttle the one or more blowers up/down based on, for example, dissolved oxygen needs.

The membrane filtration tank 312 may be connected to the bioreactor tank 310, allowing for the flow of the water output from the bioreactor tank 310 to the membrane filtration tank 312. The membrane filtration tank 312 may contain one or more membranes 314 for filtering the water that flows from the bioreactor tank 310. In some embodiments, the one or more membranes 314 may be submerged membranes. In some embodiments, the one or more membranes may be external membranes, where the membrane bioreactor 107 circulates water to an external membrane.

In some embodiments, the one or more membranes 314 may be ultrafiltration membranes having a pore size in the range of 0.01-0.1 microns, inclusive. Such ultrafiltration membranes may effectively sieve out bacteria, protozoa, and viruses, as well as any remaining fine suspended solids. It should be understood that in some other embodiments, the one or more membranes 314 may include other types of filtration membranes and/or the ultrafiltration membrane may have a pore size that is less than 0.01 microns and/or greater than 0.1 microns. The one or more membranes 314 may ensure that the treated effluent (e.g., treated greywater) is very clear and nearly free of pathogens.

In some embodiments, one or more recirculation pumps 316 may be located within the membrane filtration tank 312 or otherwise connected to the membrane filtration tank 312. The one or more recirculation pumps 308 may facilitate water circulation within the membrane filtration tank 312. For example, the one or more recirculation pumps 316 may keep water flowing across the membranes preventing fouling by scouring action, and periodic backflush or chemical cleaning systems for the membranes. The controller 132 may monitor parameters of the filtration process and/or membrane filtration tank. Such parameters may include, but not limited to, transmembrane pressure (e.g., to detect membrane fouling), biomass health (e.g., via oxidation-reduction potential or ammonia levels, etc.). The controller 132 may ensure the biology is maintained (for example, by periodically wasting some sludge to keep the microbial population in balance and not over-concentrated).

In operation, greywater may enter the bioreactor tank 310 where it undergoes biological treatment. The diffuser 304 and blower 306 may work, individually or together, to provide the necessary aeration for the biological processes. The one or more recirculation pumps 316 may ensure proper mixing and circulation of the water within the membrane filtration tank 312. After the initial biological treatment in the bioreactor tank 310, the treated water may flow into the membrane filtration tank 312, where the membranes 314 may provide an additional level of filtration, removing suspended solids and microorganisms from the water.

As described above, the membrane bioreactor 107 may be configured to adapt to variable loads. For example, in a residence, greywater production may be high in morning and evening (showers) and low in mid-day. As another example, in commercial buildings, greywater production may be heavy/high during work hours. The controller 132 may adjust aeration and flow accordingly to maintain treatment efficiency. When greywater input is low, the system may enter (e.g., switch to) a recirculation mode to keep bacteria fed (e.g., dosing a small amount of stored greywater or organic feed to avoid starvation). When greywater input is high, the system 101 may boost membrane filtration rates or divert excess to a holding tank to process later, ensuring no untreated water bypasses.

The combination of biological treatment in the bioreactor tank 310 and membrane filtration in the membrane filtration tank 312 may allow the membrane bioreactor 107 to produce high-quality treated water. This treated water may then be suitable for various non-potable uses within the closed-loop water system 101, such as irrigation or toilet flushing. The membrane bioreactor 107 may produce high-quality effluent consistently and have the benefit of a smaller footprint compared to conventional treatment (e.g., because the membranes eliminate the need for a large gravity settling tank). The combination of biological and physical treatment in one unit makes membrane bioreactor 107 particularly suitable for compact greywater recycling in buildings or contained systems. The membrane bioreactor 107 reduces the need for fresh water by making greywater available again. For example, in a typical home, toilet flushing and laundry can consume as much or more water than drinking and cooking. By recycling shower and sink water for these purposes, the demand on the AWG module 104 to produce new water is lowered.

### Example Use Cases

As described above, the system 101 may be modular and scalable (e.g., due to its modular design). For example, in some implementations (as described below), multiple AWGs and larger bioreactors may be deployed in parallel to serve greater demand, and software may be configured and leveraged to network the AWG and/or bioreactors together.

In a residential scale context such as single home, a compact implementation of the system 101 may be installed in a side yard. The residential scale system may include a single AWG 200 capable of producing 20-100 gallons of water per day (e.g., enough for drinking, cooking, laundry and other needs of a family), and a small membrane bioreactor 107 for processing greywater for toilet flushing and garden irrigation. Additionally, the residential scale system may include a modest biome tank including the biome 112. The controller 132 may integrate with the home's smart home system and the IoT remote interface 134 may be realized through the homeowner's Wi-Fi. This allows a home to significantly cut down municipal water usage by, for example, reusing shower water for toilets and by generating drinking water from air.

In a commercial building scale context such as offices, apartment complex, or the like, multiple AWG(s) 200 may be placed on the rooftop to capitalize on open air flow. Greywater from apartments or restrooms may be channeled to a central membrane bioreactor 107 in the utility room or basement. A decorative indoor pond with aquatic plants in the lobby may serve as the biome 112. The commercial building scale system may handle a few thousand gallons of water per day. The IoT monitoring may be overseen by facility management, and maintenance may be scheduled in coordination with building maintenance staff.

In an industrial facility scale context, an industry (e.g., small factory or the like) may implement the system 101 to recycle its process water and generate water for process use or worker consumption. In one example, AWGs 200 may be integrated with industrial cooling towers. The cooling towers may evaporate large amounts of water for cooling. By capturing the humidity through AWGs placed near the exhaust, the industrial facility scale system may reclaim water that would otherwise be lost to the sky. This reduces the raw water intake for the cooling tower. The membrane bioreactor 107 may treat mixed wastewater. The controller 132 (e.g., AI component thereof) may be leveraged for process optimization and ensuring water quality meets industrial specifications. IoT monitoring may be leveraged for regulatory compliance such as providing logs of how water is recycled.

In a municipal scale (e.g., community water system context), a full-scale deployment may include a water generation and recycling plant servicing multiple buildings. A large atmospheric water generation plant may produce thousands of gallons of water per day from the atmosphere. In parallel, the town's greywater (e.g., if separated from blackwater at the source or via a dual-piping system in homes) may be sent to a central treatment facility with large membrane bioreactor tanks and extensive wetlands (e.g., as a park area) that have been built for the community. The potable water from the AWG(s) and recycled water may be combined to supply the municipal water network for non-potable uses, and with advanced treatment could supplement potable supply. Blackwater (sewage) may be sent to a conventional sewage plant or be minimized via composting/incineration toilets as an auxiliary measure. The controller 132 may run on powerful hardware and incorporate weather data on a regional scale. The controller 132 may coordinate multiple community systems, balancing loads between them. IoT monitoring may allow city water engineers to supervise the distributed system comprehensively. The result may be a municipality that has significantly reduced reliance on external water or groundwater extraction, using the local humidity and wastewater as resources.

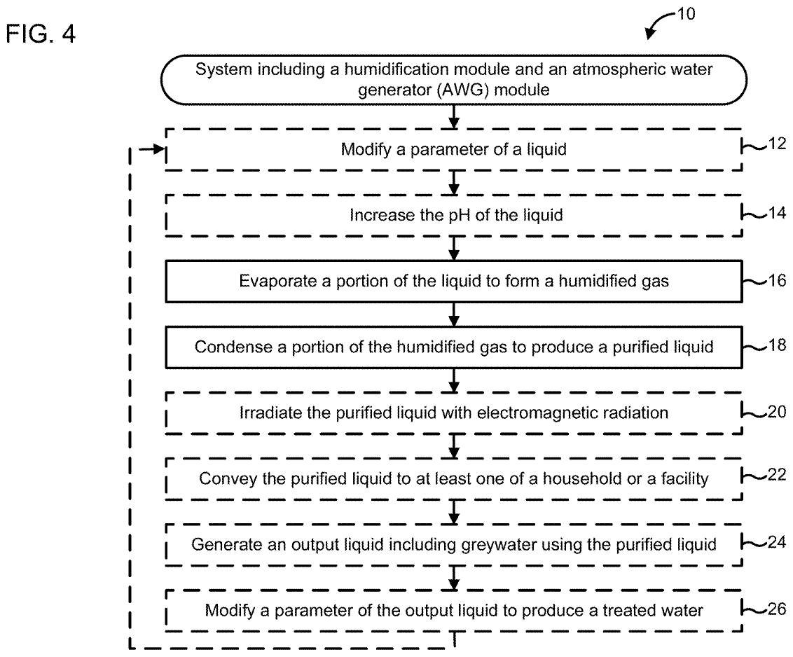

FIG. 4 is a block flow diagram of a method 10 of water generation and purification, according to an embodiment. In some embodiments, the method 10 may include or be performed by the system 100 as described herein with respect to FIG. 1A. For example, in some embodiments, the system 100 may include the AWG module 104, the water storage and distribution module 114, the greywater recycling module 106, the natural treatment module 110, the humidification module 118, the facility 102, the control and monitoring module 130 any suitable components thereof, and/or any of the features described herein with respect to FIG. 1A. Accordingly, operations of the method 10, may be performed by any suitable features of the system 100. While described with respect to the system 100 of FIG. 1A and features thereof, in some embodiments, the operations of the method 10 may include or be performed by any suitable systems and/or the features thereof as described herein (e.g., the system 101). All such variations are envisioned herein and should be considered as part of the present disclosure.

In some embodiments, the method 10 may optionally include modifying a parameter of the liquid input 142, at 12. For example, in some embodiments, the system 100 may include the humidification module 118, wherein the humidification module 118 may be configured to modify a parameter of the liquid input 142. In some embodiments, the humidification module 118 may include the purification module 170 that is configured to alter a parameter of the liquid input 142. For example, in some embodiments, the purification module 170 may be configured to modify one or more or a pH, an alkalinity, an ionic strength, a surface tension, or a surfactant activity level of the liquid input 142. In some embodiments, the humidification module 118 may include the conditioner 109, that is configured to reduce aerosol formation within and/or surfactant activity of the liquid input 142, for example, to inhibit contaminants from being entrained into the aerosol, as described herein.

In some embodiments, the method 10 may optionally include modifying a parameter of the greywater 124, at 12. For example, in some embodiments, the greywater recycling module 106 may be configured to modify a parameter of the greywater 124. In some embodiments, the greywater recycling module 106 may include the conditioner 109, that may be configured to reduce aerosol formation within and/or surfactant activity of the liquid input 142. In some embodiments, the liquid input 142 may contain a contaminant. For example, in some embodiments, the liquid input 142 may contain a per-or polyfluoroalkyl substance (PFAS). In some embodiments, one or more of the purification module 170 or the conditioner 109 may be configured to alter a parameter of the liquid input 142 such that the contaminant(s) contained therein do not volatilize. For example, in some embodiments, the conditioner 109 may be configured to reduce the aerosol formation within and/or the surfactant activity of the liquid input 142 such that the entrainment of droplets containing the PFAS into another module of the system 100 is reduced. All such variations are envisioned herein and should be considered a part of the present disclosure.

In some embodiments, the method 10 may optionally include increasing the pH of the liquid input 142, at 14. For example, in some embodiments, the humidification module 118 may be configured to increase the pH of the liquid input 142. In some embodiments, the humidification module 118 may include the purification module 170, that is configured to increase the pH of the liquid input 142. For example, in some embodiments, the purification module 170 may be configured to add a buffer or a base to the liquid input 142 such that the pH of the liquid input 142 increases as a result of the added buffer or base. In some embodiments, the liquid input 142 may contain a contaminant including a per-or polyfluoroalkyl substance (PFAS). In such embodiments, the purification module 170 may be configured to alter the pH of the liquid input 142 such that the PFAS therein remain in an ionic salt form. In some embodiments, the humidification module 118 may include the conditioner 109, wherein the conditioner 109 may be configured to increase the pH of the liquid input 142. For example, in some embodiments, the liquid input 142 may contain a contaminant including PFAS. In such embodiments, the conditioner 109 may be configured to alter the pH of the liquid input 142 such that the PFAS therein remain in an ionic salt form. All such variations are envisioned herein and should be considered a part of the present disclosure. In some embodiments, in some the buffer or base used to adjust the pH of the liquid input 142 may have a pH of greater than or equal to 7 (e.g., at least about 7, at least about 7.5, at least about 8, at least about 8.5, or at least about 9, or no more than about 10, no more than about 9.5, no more than about 9, no more than about 8.5, no more than about 8, or more than about 7.5, or about 7, about 7.5, about 8, about 8.5, about 9, about 9.5, or about 10, including all ranges and values therebetween).

In some embodiments, the method 10 may include evaporating at least a portion of the liquid input 142 to form the humidified gas 129, at 16. For example, in some embodiments, the humidification module 118 may be configured to evaporate at least a portion of the liquid input 142 to form the humidified gas. In some embodiments, the humidification module 118 may include one or more humidifiers 117 wherein the one or more humidifiers 117 may be configured to evaporate at least a portion of the liquid input 142 to form the humidified gas 129. For example, in some embodiments, the one or more humidifiers 117 may include a heat source 119 configured to heat the portion of the liquid input 142 such that it evaporates to form the humidified gas 129. In some embodiments, the humidification module 118 may include the purification module 170 configured to evaporate the portion of the liquid input 142 to form the humidified gas 129. For example, in some embodiments, the purification module 170 may be configured to contact the liquid input 142 with air such that mass transfer occurs between the air and the liquid input 142 evaporating the portion of the liquid input 142 to form the humidified gas 129. All such variations are envisioned herein and should be considered a part of the present disclosure.

In some embodiments, the method 10 may include condensing a portion of the humidified gas 129 to produce the purified liquid 120, at 18. For example, in some embodiments, the AWG module 104 may be configured to condense the portion of the humidified gas 129 to produce the purified liquid 120. In some embodiments, the AWG module 104 may include one or more atmospheric water generators 200 wherein the atmospheric water generators 200 may be configured to condense the portion of the humidified gas 129 to form the purified liquid 120. In some embodiments, the purified liquid 120 may include potable water. For example, in some embodiments, the AWGs 200 may include air intake fans, air filters, a cooling condensation unit (e.g., evaporator coil and compressor system), a desiccant-based sorption unit, and/or a condensation surface or chamber wherein water vapor within the purified liquid 120 is converted to liquid water. All such variations are envisioned herein and should be considered a part of the present disclosure.

In some embodiments, the method 10 may optionally include irradiating the purified liquid 120 with electromagnetic radiation, at 20. For example, in some embodiments, the greywater recycling module 106 may be configured to irradiate the purified liquid 120 with electromagnetic energy (e.g., UV light). In some embodiments, the greywater recycling module 106 may include the membrane bioreactor 107. In some embodiments, the membrane bioreactor may include a UV disinfection unit wherein the UV disinfection unit may be configured to irradiate the purified liquid 120 with electromagnetic energy. In some embodiments, irradiating the purified liquid 120 with electromagnetic energy may help to sterilize the purified liquid 120. For example, in some embodiments, irradiating the purified liquid 120 may help inactivate any microorganisms therein. All such variations are envisioned herein and should be considered a part of the present disclosure.

In some embodiments, the method 10 may optionally include conveying the purified liquid 120 to at least one of a household or the facility 102, at 22. For example, in some embodiments, the closed-loop water system 101 may be configured to convey the purified liquid 120 to at least one of a household or the facility 102. In some embodiments, the closed-loop water system 101 may include the AWG module 104 that may be fluidically couplable to the facility 102 and configured to convey the purified liquid 120 thereto. In some embodiments, the closed-loop water system 101 may include the natural treatment water module 110 that may be fluidically couplable to the facility 102 and the natural water module 110 may be configured to convey the purified liquid 120 thereto. In some embodiments the closed-loop water system 101 may include the water storage and distribution module 114 that may be fluidically couplable to the facility 102 and the water storage and distribution module 114 may be configured to convey the purified liquid 120 containing a potable water thereto. All such variations are envisioned herein and should be considered a part of the present disclosure.

In some embodiments, the method 10 may optionally include generating an output liquid including the greywater 124 using the purified liquid 120 as an input, at 24. For example, in some embodiments, the facility 102 may be configured to generate an output liquid including the greywater from the purified liquid 120. In some embodiments, the facility 102 may be configured to generate an output liquid including the greywater 124 via supplying one or more fixtures (e.g., taps, showers, toilets, irrigation lines, industrial process feeds) with the purified liquid 120 including potable water and/or a portion of the treated water 126. All such variations are envisioned herein and should be considered a part of the present disclosure.

In some embodiments, the method 10 may optionally include modifying a parameter of the output liquid to produce the treated water 126, at 26. For example, in some embodiments, the greywater recycling module 106 may be configured to modify a parameter of the output liquid to produce the treated water 126. In some embodiments, the greywater recycling module 106 may include the membrane bioreactor 107 that may be configured to modify a parameter of the output liquid to produce the treated water 126. For example, in some embodiments, the membrane bioreactor 107 may be configured to biologically treat and filter the output liquid including the greywater 124 to produce the treated water 126. In some embodiments, the membrane bioreactor 107 may include a bioreactor with microorganisms that may break down organic contaminants within the output liquid including the greywater 124, and an ultrafiltration membrane that may filter out remaining solids and pathogens therefrom to produce the treated water 126. In some embodiments, the natural treatment module 110 may configured to modify a parameter of the output liquid to produce the treated water 126. In some embodiments, the natural treatment module 110 may include the biome 112 that may be configured to modify a parameter of the output liquid to produce the treated water 126. For example, in some embodiments, the biome 112 (e.g., a greenhouse) may include plants, algae, and/or beneficial microbes/microorganisms through which the output liquid may be flowed to produce the treated water 126. In some embodiments, the biome 112 may include plant roots and/or microbes and as the output liquid is flowed through the biome the plant roots and microbes may remove residual nutrients and contaminants, thus, improving water quality naturally. All such variations are envisioned herein and should be considered a part of the present disclosure.

In some embodiments, the operations of the method 10 may optionally be performed cyclically. For example, in some embodiments, the system 100 may be configured to perform the operations of the method 10 using the treated water 126 at 26 as the liquid input 142, at 12 (e.g., repeat operations 12 to 26 using recycled water). All such variations are envisioned herein and should be considered a part of the present disclosure.

In some embodiments, a system includes: a humidification module configured to: receive a liquid having a first concentration of a contaminant, and evaporate at least a portion of the liquid to form: a gas having a relative humidity greater than or equal to a predetermined relative humidity threshold, and a liquid concentrate having a second concentration of the contaminant, the second concentration greater than the first concentration; and an atmospheric water generator (AWG) module fluidically couplable to the humidification module, the AWG module configured to receive at least one of the gas or an environmental air and extract moisture from at least a portion of the at least one of the received gas or the received environmental air to produce purified water.

In some embodiments, the humidification module is configured to contact the liquid with air to cause mass transfer from the liquid to the air such that the portion of the liquid is evaporated.

In some embodiments, the AWG module is configured to extract moisture from the at least one of the received gas or the received environmental air via at least one of condensation or sorption to produce the purified water.

In some embodiments, waste heat from at least one the AWG module, an HVAC system, or solar thermal collectors is used to drive the evaporation of the at least the portion of the liquid.

In some embodiments, the system further includes a facility fluidically couplable to the AWG module, the facility configured to: receive the purified water, and generate a used water.

In some embodiments, the system further includes recycling module fluidically couplable to at least the facility, the recycling module having a membrane bioreactor configured to: receive used water from one or more sources, and alter a parameter of the used water to produce a recycled water.

In some embodiments, the system further includes a natural treatment module having a biome including microorganisms therein, the natural treatment module fluidically couplable to at least the recycling module, the natural treatment module configured to receive the recycled water and alter a parameter of the recycled water.

In some embodiments, the system further includes a one or more sensors and a controller configured to: interpret signals received from the one or more sensors and to determine a parameter of the system, and alter an operation of at least one of the AWG module or the humidification module based on the determined parameter.

In some embodiments, the AWG module, the facility, the recycling module, and the humidification module are configured to operate in a closed loop such that atmospheric water extraction via the AWG module compensates for water losses and supplements water supply, while the recycled water is continuously reused, thereby reducing net external water input.

In some embodiments, the controller is configured to adjust an operation of the AWG module to increase water harvesting during a first time interval with a first ambient relative humidity equal to or greater than a predetermined relative humidity threshold and to conserve energy during a second time interval with a second ambient relative humidity, the second ambient relative humidity less than the first ambient relative humidity.

In some embodiments, the controller is configured to communicate a signal to an external entity in response to detecting a change in one or more monitored parameters of the system.

In some embodiments, the recycling module includes an equalization tank and at least one flow control valve configured to prevent modular overflow in response to an intermittent surge input.

In some embodiments, a method includes causing a portion of a liquid having a first concentration of a contaminant to evaporate to form a gas having a relative humidity greater than or equal to a predetermined relative humidity threshold, a liquid concentrate having a second concentration of the contaminant greater than the first concentration; and causing at least a portion of the gas to condense to produce a purified liquid.

In some embodiments, the portion of the liquid is a first portion, and the method further includes: modifying a parameter of the liquid to cause at least a portion of the contaminant to remain in a second portion of the liquid.

In some embodiments, the contaminant includes at least one of a polyfluoroalkyl compound, a fluorinated surfactant, or a related organic compound, and modifying the parameter of the liquid includes increasing a pH of the liquid to at least a predetermined pH threshold such that at least a portion of the polyfluoroalkyl compound remains in the second portion of the liquid.

In some embodiments, the method further includes introducing a buffer or base into the liquid to increase the pH of the liquid to at least the predetermined pH threshold, the buffer or base having a pH greater than or equal to 7.

In some embodiments, the method further includes irradiating the purified liquid with electromagnetic radiation to alter a parameter of the purified liquid.

In some embodiments, the method further includes utilizing the purified liquid to produce an output liquid including a greywater.

In some embodiments, the method further includes biologically and physically modifying a parameter of the greywater to produce a recycled water.

In some embodiments, at least one of: the liquid is evaporated using waste heat from at least one an AWG module, an HVAC system, or solar thermal collectors; or the gas is condensed using via at least one of condensation or sorption to produce the purified water.

In some embodiments, a method includes altering a parameter of a liquid containing a contaminant such that at least a portion of the contaminant does not volatilize; evaporating at least a portion of the liquid to form a gas, the gas having a relative humidity equal to or greater than a predetermined relative humidity value; extracting at least a portion of moisture in the gas via at least one of condensation or sorption to generate a purified liquid.

In some embodiments, evaporating at least a portion of the liquid includes contacting the liquid with air to cause mass transfer from the liquid to the air such that the portion of the liquid is evaporated.

In some embodiments, at least the portion of the liquid is evaporated using waste heat from at least one an AWG module, an HVAC system, or solar thermal collectors.

In some embodiments, the at least the portion of the moisture in the gas is extracted using via at least one of condensation or sorption.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and operations described above indicate certain events occurring in a certain order, those of ordinary skill in the art having the benefit of this disclosure would recognize that the ordering of certain operations may be modified and such modification are in accordance with the variations of the invention. Additionally, certain of the operations may be performed concurrently in a parallel process, when possible, as well as performed sequentially as described above. The embodiments have been particularly shown and described, but it will be understood that various changes in form and details may be made.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A system, comprising:
a humidification module configured to:
receive a liquid having a first concentration of a contaminant, and
evaporate at least a portion of the liquid to form:
a gas having a relative humidity greater than or equal to a predetermined relative humidity threshold, and
a liquid concentrate having a second concentration of the contaminant, the second concentration greater than the first concentration; and
an atmospheric water generator (AWG) module fluidically couplable to the humidification module, the AWG module configured to receive at least one of the gas or an environmental air and extract moisture from at least a portion of the at least one of the received gas or the received environmental air to produce purified water.

2. The system of claim 1, wherein the humidification module is configured to contact the liquid with air to cause mass transfer from the liquid to the air such that the portion of the liquid is evaporated.

3. The system of claim 1, wherein the AWG module is configured to extract moisture from the at least one of the received gas or the received environmental air via at least one of condensation or sorption to produce the purified water.

4. The system of claim 1, wherein waste heat from at least one the AWG module, an HVAC system, or solar thermal collectors is used to drive the evaporation of the at least the portion of the liquid.

5. The system of claim 1, further comprising:
a facility fluidically couplable to the AWG module, the facility configured to:
receive the purified water, and
generate a used water.

6. The system of claim 5, further comprising:
a recycling module fluidically couplable to at least the facility, the recycling module having a membrane bioreactor configured to:
receive used water from one or more sources, and
alter a parameter of the used water to produce a recycled water.

7. The system of claim 6, further comprising:
a natural treatment module having a biome including microorganisms therein, the natural treatment module fluidically couplable to at least the recycling module, the natural treatment module configured to receive the recycled water and alter a parameter of the recycled water.

8. The system of claim 5, further comprising a one or more sensors and a controller, the controller configured to:
interpret signals received from the one or more sensors and to determine a parameter of the system, and
alter an operation of at least one of the AWG module or the humidification module based on the determined parameter.

9. The system of claim 8, wherein the AWG module, the facility, the recycling module, and the humidification module are configured to operate in a closed loop such that atmospheric water extraction via the AWG module compensates for water losses and supplements water supply, while the recycled water is continuously reused, thereby reducing net external water input.

10. The system of claim 8, wherein the controller is configured to adjust an operation of the AWG module to increase water harvesting during a first time interval with a first ambient relative humidity equal to or greater than a predetermined relative humidity threshold and to conserve energy during a second time interval with a second ambient relative humidity, the second ambient relative humidity less than the first ambient relative humidity.

11. The system of claim 8, wherein the controller is configured to communicate a signal to an external entity in response to detecting a change in one or more monitored parameters of the system.

12. The system of claim 8, wherein the recycling module includes an equalization tank and at least one flow control valve configured to prevent modular overflow in response to an intermittent surge input.

13. A method, comprising:
causing a portion of a liquid having a first concentration of a contaminant to evaporate to form a gas having a relative humidity greater than or equal to a predetermined relative humidity threshold, a liquid concentrate having a second concentration of the contaminant greater than the first concentration; and
causing at least a portion of the gas to condense to produce a purified liquid.

14. The method of claim 13, wherein the portion of the liquid is a first portion, the method further comprising:
modifying a parameter of the liquid to cause at least a portion of the contaminant to remain in a second portion of the liquid.

15. The method of claim 14, wherein:
the contaminant includes at least one of a polyfluoroalkyl compound, a fluorinated surfactant, or a related organic compound, and
modifying the parameter of the liquid includes increasing a pH of the liquid to at least a predetermined pH threshold such that at least a portion of the polyfluoroalkyl compound remains in the second portion of the liquid.

16. The method of claim 15, further comprising:
introducing a buffer or base into the liquid to increase the pH of the liquid to at least the predetermined pH threshold, the buffer or base having a pH greater than or equal to 7.

17. The method of claim 13, further comprising:
irradiating the purified liquid with electromagnetic radiation to alter a parameter of the purified liquid.

18. The method of claim 13, further comprising:
utilizing the purified liquid to produce an output liquid including a greywater.

19. The method of claim 18, further comprising:
biologically and physically modifying a parameter of the greywater to produce a recycled water.

20. The method of claim 13, wherein at least one:
the liquid is evaporated using waste heat from at least one an AWG module, an HVAC system, or solar thermal collectors; or
the gas is condensed using via at least one of condensation or sorption to produce the purified water.

21. A method comprising:
altering a parameter of a liquid containing a contaminant such that at least a portion of the contaminant does not volatilize;
evaporating at least a portion of the liquid to form a gas, the gas having a relative humidity equal to or greater than a predetermined relative humidity value;
extracting at least a portion of moisture in the gas via at least one of condensation or sorption to generate a purified liquid.

22. The method of claim 21, wherein evaporating at least a portion of the liquid includes contacting the liquid with air to cause mass transfer from the liquid to the air such that the portion of the liquid is evaporated.

23. The method of claim 21, wherein at least the portion of the liquid is evaporated using waste heat from at least one an AWG module, an HVAC system, or solar thermal collectors.

24. The method of claim 21, wherein the at least the portion of the moisture in the gas is extracted using via at least one of condensation or sorption.
